(19) United States
(12) Patent Application Publication
(10) Pub. No.: US 2002/0073110 A1
(43) Pub. Date: Jun. 13, 2002

(54) Version collection technique implemented on an intrinsic versioning information storage and retrieval system

(76) Inventors: Edouard Duvillier, Sunnyvale, CA (US); Didier Cabannes, Burlingame, CA (US)

Correspondence Address: BEYER WEAVER & THOMAS LLP, P.O. BOX 778, BERKELEY, CA, 94704-0778, US

(21) Appl. No.: 09/976,864

(22) Filed: Oct. 12, 2001

Related U.S. Application Data
(63) Continuation-in-part of application No. 09/736,039, filed on Dec. 12, 2000.

(51) Int. Cl. G06F 12/00

(52) U.S. Cl. 707/206

(57) ABSTRACT

A technique is disclosed for implementing collection of obsolete object versions stored in an information storage and retrieval system. The information storage and retrieval system includes persistent memory configured or designed to store a plurality of different object versions. The information storage and retrieval system further includes volatile memory which may be configured to store an object table which includes object version information relating to the plurality of object versions. The object version information includes information relating to locations in the persistent memory where each of the plurality of object versions are stored. A version collection procedure is initiated. At least one object version may then be identified as an obsolete object version without performing a memory access operation to the persistent memory to retrieve information relating to the at least one object version. In one embodiment, the identification of the obsolete object version may be accomplished using information contained in the object table. Further according to specific embodiments, the information storage and retrieval system may correspond to a non-log based information storage and retrieval system which is configured or designed to implement intrinsic versioning of objects stored within the system.

### RELATED APPLICATION DATA

This application is a continuation-in-part of U.S. patent application Ser. No. 09/736,039 to Duvillier et al., filed on Dec. 12, 2000, the entirety of which is incorporated herein by reference in its entirety for all purposes.

### BACKGROUND OF THE INVENTION

In U.S. patent application Ser. No. 09/736,039 (herein referred to as the “Parent Application”), a non-log based information storage and retrieval system is described.

The non-log based information storage and retrieval system described in the Parent Application provides for intrinsic versioning of objects stored in a database. According to specific embodiments, an object stored in the database may be identified using a corresponding object ID associated with that particular object. Each object may have one or more versions (herein referred to as “object versions”) associated therewith, which are also stored in the database. Each object version may be identified by a respective version ID. Thus, for example, when a new version of a particular object is stored in the database, the new version is assigned a unique version ID in order to differentiate that object version from other, previous versions of the same object.

As described in the Parent Application, the database includes persistent memory for storing the plurality of different object versions of the database. According to specific embodiments, the persistent memory may be configured to include a plurality of disk pages, wherein one or more object versions may be stored at a memory location in the persistent memory corresponding to a particular disk page.

As described in the Parent Application, an object version collection procedure is periodically implemented in order to collect and garbage obsolete object versions stored in the persistent memory. In one embodiment, an obsolete object version may be defined as an older version of an object which is not currently being accessed. An example of an object version collection procedure is described in FIGS. 19 and 20A of the drawings in the Parent Application. As described in this embodiment, the object version collection procedure is configured to retrieve disk pages from the persistent memory, and analyze the retrieved disk pages for obsolete object versions stored therein. It will be appreciated that such an implementation of the object version collection procedure necessarily involves multiple disk access operations in order to retrieve desired disk pages from the persistent memory.

Typically, delays associated with accessing information from disk or persistent memory may be many orders of magnitude greater than delays associated with accessing information from volatile memory, such as RAM. For example, the disk access delay attributable to accessing a disk page from the persistent memory may be about 10 milliseconds, whereas the delay associated with accessing information from the working memory (e.g. volatile memory) may be several microseconds. Accordingly, it will be appreciated that much of the execution time associated with implementing the object version collection procedure described in the Parent Application may be attributable to delays associated with accessing information from the persistent memory. Moreover, when managing large data sets which include millions of objects, the cumulative affect of such access delays may significantly degrade system performance and responsiveness.

Accordingly, it will be appreciated that it is generally desirable to improve upon features relating to the non-log based information storage and retrieval system described in the Parent Application.

### SUMMARY OF THE INVENTION

According to several embodiments of the present invention, various methods, systems, and/or computer program products are disclosed for implementing collection of obsolete object versions stored in an information storage and retrieval system. The information storage and retrieval system includes persistent memory configured or designed to store a plurality of different object versions. The information storage and retrieval system further includes volatile memory which may be configured to store an object table which includes object version information relating to the plurality of object versions. The object version information includes information relating to locations in the persistent memory where each of the plurality of object versions are stored. A version collection procedure is initiated. At least one object version may then be identified as an obsolete object version without performing a memory access operation to the persistent memory to retrieve information relating to the at least one object version.

Alternate embodiments of the present invention are directed to methods, systems, and/or computer program products for implementing collection of obsolete object versions stored in an information storage and retrieval system. The information storage and retrieval system includes persistent memory configured or designed to store a plurality of different object versions. The information storage and retrieval system further includes volatile memory which may be configured to store an object table which includes object version information relating to the plurality of object versions. The object version information includes information relating to locations in the persistent memory where each of the plurality of object versions are stored. A version collection procedure is initiated. At least one object version may then be identified as an obsolete object version, wherein the identifying of the at least one obsolete object version is accomplished using information stored entirely in volatile memory.

According to a specific embodiment, at least one object may be identified for version collection analysis without performing a memory access operation to the persistent memory to retrieve information relating to the at least one object. In one embodiment, the identification of the obsolete object version may be accomplished using information contained in the object table. Further according to specific embodiments, the information storage and retrieval system may correspond to a non-log based information storage and retrieval system which is configured or designed to implement intrinsic versioning of objects stored within the system.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIG. 1A shows a schematic block diagram of an information storage and retrieval system 100 in accordance with a specific embodiment of the present invention.

FIG. 1B shows an alternate embodiment of the information storage and retrieval system of the present invention.

FIG. 2 shows a block diagram illustrating how an object version collection technique may be implemented in a specific embodiment of the database system of the present invention.

FIG. 3 shows a flow diagram of a Checkpointing Version Collector Procedure 2000 in accordance with a specific embodiment of the present invention.

FIG. 4 shows a flow diagram of a Version Collection Procedure A 400 in accordance with an alternate embodiment of the present invention.

FIG. 5A shows a flow diagram of Get Object Version ID Procedure 500 in accordance with a specific embodiment of the present invention.

FIG. 5B shows an alternate embodiment of a Get Object Version ID Procedure 550 in accordance with a specific embodiment of the present invention.

FIG. 6 shows a flow diagram of an Object Collection Analysis Procedure 600 in accordance with a specific embodiment of the present invention.

FIG. 7 shows a block diagram of a locked version tree (LV Tree) or list 700, in accordance with a specific embodiment of the present invention.

FIG. 8A shows a specific embodiment of a block diagram of a disk page buffer 800 in accordance with a specific embodiment of the present invention.

FIG. 8B shows a block diagram of a version of a database object 880 in accordance with a specific embodiment of the present invention.

FIG. 8C shows a block diagram of an Allocation Map entry 1800 in accordance with a specific embodiment of the present invention.

FIG. 9A shows an example of an LV Tree 910 which may be used to illustrate various aspects of the present invention.

FIG. 9B shows a portion of an object table 920 in accordance with a specific embodiment the present invention.

FIG. 10 shows an alternate embodiment of a Version Collection Analysis Procedure B 1000 in accordance with a specific embodiment of the present invention.

FIG. 11 shows a flow diagram of an Object Collection Analysis Procedure B 1100 in accordance with a specific embodiment of the present invention.

FIG. 12 shows an alternate embodiment of a Version Collection Procedure C 1200 in accordance with a specific embodiment of the present invention.

FIG. 13 shows a flow diagram of an Object Collection Analysis Procedure C 1300 in accordance with a specific embodiment of the present invention.

FIG. 14 shows a block diagram of a VC Disk MAP 1400 in accordance with a specific embodiment of the present invention.

FIG. 15 shows a specific embodiment of a block diagram illustrating how different portions of the Object Table 1501 maybe stored within the information storage and retrieval system of the present invention.

FIG. 16 shows a system suitable for implementing the information storage and retrieval technique of the present invention

### DETAILED DESCRIPTION OF THE PREFERRED EMBODIMENTS

According to various embodiments of the present invention, a number of different techniques are disclosed for reducing the overall run time or execution time associated with implementing an object version collection procedure, such as that described, for example, in the Parent Application. According to specific embodiments, the overall execution time of the object version collection procedure may be reduced by using information stored in volatile memory (such as, for example, information stored within an object table residing in RAM) in determining whether to free selected disk pages in the persistent memory which include at least one obsolete object version. For example, according to a first embodiment, obsolete object versions stored in the persistent memory may be identified using information stored in an object table (which resides in the volatile memory such as, for example, working memory or program memory). If it is determined that an identified obsolete object version is stored on a single disk page in the persistent memory, and that the identified disk page does not contain other object versions, then the identified disk page (in the persistent memory) which contains the identified obsolete object version may be freed or released. In this way, at least a portion of the obsolete object versions stored in the persistent memory may be garbaged or discarded (and the corresponding persistent memory space freed) without having to perform any disk access operations in order to identify and release obsolete object versions stored in the persistent memory. Thereafter, according to a specific implementation, the object version collection procedure may then be configured to retrieve selected disk pages from the persistent memory in order to identify and release any remaining obsolete object versions stored in the persistent memory.

According to an alternate embodiment, one or more data structures may be maintained in the volatile memory, and used to keep track of disk pages in the persistent memory which contain obsolete object versions that have not been freed or released. As explained in greater detail below, this latter embodiment provides a mechanism for implementing object version collection with significant reduction or elimination of disk access operations in order to identify and release obsolete object versions stored in the persistent memory.

In order to gain a better understanding of the various aspects of the present invention, it will be helpful to briefly review certain aspects of the information storage and retrieval system described in the parent application, as well as the object version collection procedure described in the Parent Application.

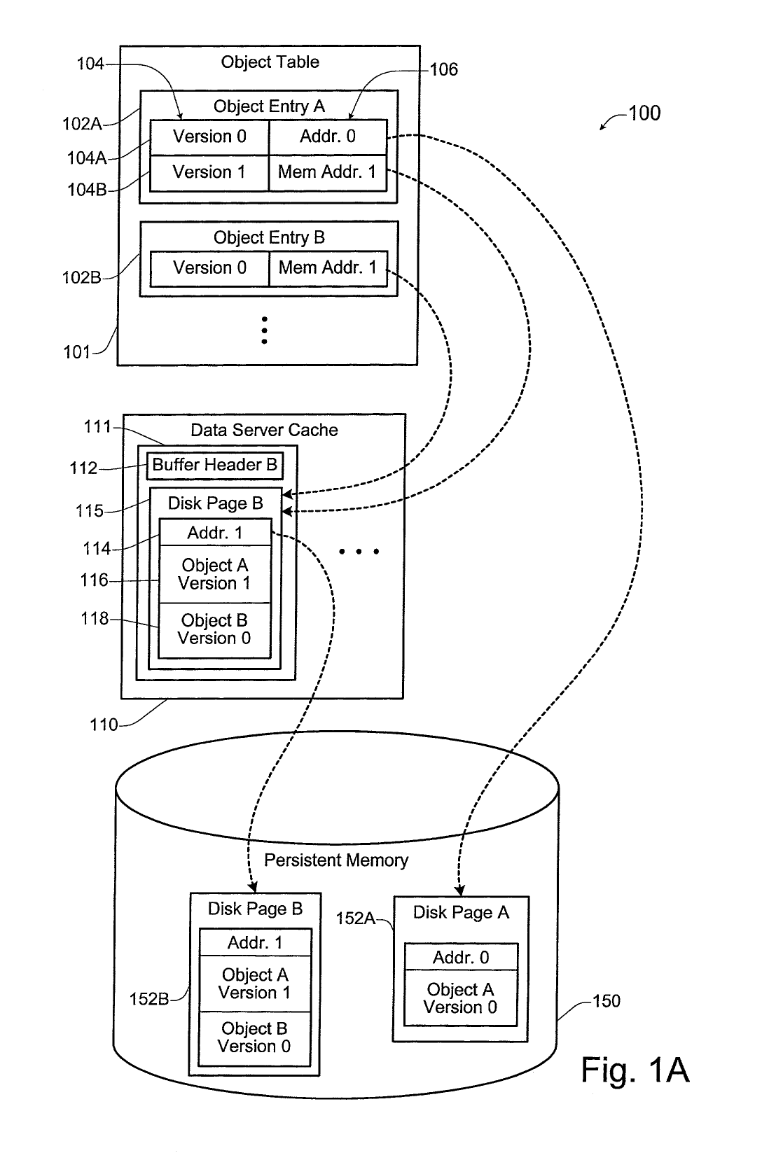

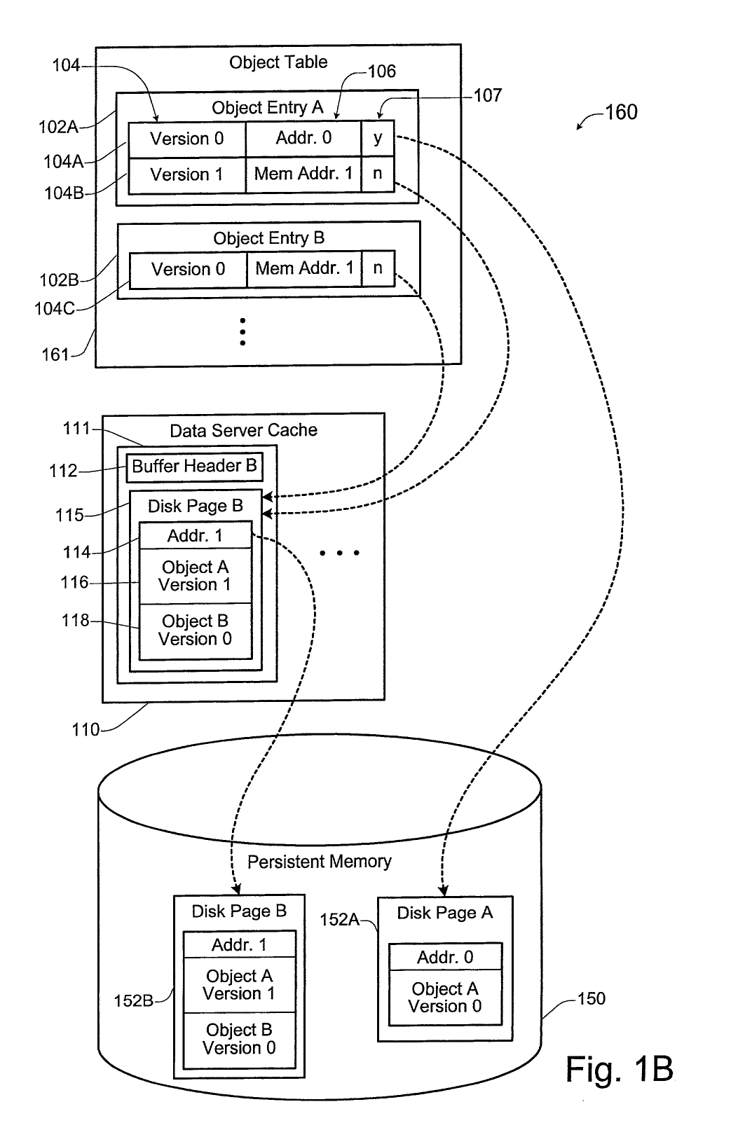

FIG. 1A shows a schematic block diagram of an information storage and retrieval system 100 in accordance with a specific embodiment of the present invention. As shown in FIG. 1A, the system 100 includes a number of internal structures which provide a variety of information storage and retrieval functions, including, for example, the translation of logical object IDs to physical locations where the objects are stored. The main structures of the database system 100 of FIG. 1A include at least one Object Table 101, at least one data server cache such as data server cache 110, and at least one persistent memory database 150 such as, for example, a disk drive.

As shown in FIG. 1A, the Object Table 101 may include a plurality of entries (e.g. 102A, 102B, etc.). Each entry in Object Table 101 may be associated with one or more versions of objects stored in the database. For example, in the embodiment of FIG. 1A, Object Entry A (102A) is associated with a particular object identified as Object A. Additionally, Object Entry B (102B) is associated with a different object stored in the database, identified as Object B. As shown in Object Table 101, Object A has 2 versions associated with it, namely Version 0 (104A) and Version 1 (104B). In the example of FIG. 1A, it is assumed that Version 1 corresponds to a more recent version of Object A than Version 0. Object Entry B represents a single version object wherein only a single version of the object (e.g. Object B, Version 0) is stored in the database.

According to a specific implementation, the version ID values which are assigned to the various object versions in the database may represent logical time reference values. In such embodiments, the version ID values may be used to determine the relative age of one or more object versions relative to a given version ID value. For example, according to one implementation, the version ID values may be assigned in a sequential manner to all atomically committed transactions.

As shown in the embodiment of FIG. 1A, each version of each object identified in Object Table 101 is stored within the persistent memory data structure 150, and may also be stored in the data server cache 110. More specifically, Version 0 of Object A is stored on a disk page 152A (Disk Page A) within data structure 150 at a physical memory location corresponding to “Address 0”. Version 1 of Object A is stored on a disk page 152B (Disk Page B) within data structure 150 at a physical memory location corresponding to “Address 1”. Additionally, as shown in FIG. 1A, Version 0 of Object B is also stored on Disk Page B within data structure 150.

When desired, one or more selected object versions may also be stored in the data server cache 110. According to a specific embodiment, the data server cache may be configured to store copies of selected disk pages located in the persistent memory 150. For example, as shown in FIG. 1A, data server cache 110 includes at least one disk page buffer 111 which includes a buffer header 112, and a copy 115 of Disk Page B 152B. The copy of Disk Page B includes both Version 1 of Object A (116), and Version 0 of Object B (118).

As shown in FIG. 1A, each object version represented in Object Table 101 includes a corresponding address 106 which may be used to access a copy of that particular object version which is stored in the database system 100. According to a specific embodiment, when a particular copy of an object version is stored in the data server cache 110, the address portion 106 of that object version (in Object Table 101) will correspond to the memory address of the location where the object version is stored in the data server cache 110. Thus, for example, as shown in FIG. 1A, the address corresponding to Version 1 of Object A in Object Table 101 is Memory Address 1, which corresponds to the disk page 115 (residing in the data server cache) that includes a copy of Object A, Version 1 (116). Additionally, the address corresponding to Version 0 of Object B (in Object Table 101) is also Memory Address 1 since Disk Page B 115 also includes a copy of Object B, Version 0 (118).

As shown in FIG. 1A, Disk Page B 115 of the data server cache includes a separate address field 114 which points to the memory location (e.g. Addr. 1) where the Disk Page B 152B is stored within the persistent memory data structure 150.

As described in greater detail below, the system 100 of FIG. 1A may be used to implement a semantic network object model. The object model integrates many of the standard features of conventional object database management systems such as, for example, classes, multiple inheritance, methods, polymorphism, etc. The application schema may be language independent and may be stored in the database. The dynamic schema capability of the database system 100 of the present invention allows a user to add or remove classes or properties to or from one or more objects while the system is on-line. Moreover, the database management system of the present invention provides a number of additional advantages and features which are not provided by conventional object database management systems (ODBMSs) such as, for example, text-indexing, intrinsic versioning, ability to handle real-time feeds, ability to preserve recovery data without the use of traditional log files, etc. Further, the database system 100 automatically manages the integrity of relationships by maintaining by-directional links between objects. Additionally, the data model of the present invention may be dynamically extended without interrupting production systems or recompiling applications.

According to a specific embodiment, the database system 100 of FIG. 1A may be used to efficiently manage BLOBs (such as, for example, multimedia data types) stored within the database itself. In contrast, conventional ODBMS and RDBMS systems typically do not store BLOBs within the database itself, but rather resort to storing BLOBs in file systems external to the database. According to one implementation, the database system 100 may be configured to include a plurality of media APIs which provide a way to access data at any position through a media stream, thereby enabling an application to jump forward, backward, pause, and/or restart at any point of a media or binary stream.

FIG. 1B shows an alternate embodiment of the information storage and retrieval system of the present invention. As shown in the embodiment of FIG. 1B, the Object Table 161 also includes additional information 107 relating to the contents of the Disk Page Associated with each respective object version entry in the Object Table. For example, according to specific implementation, each entry (e.g. 104A, 104B, 104C) in the Object Table 161 may include an additional bit or flag which may be used for indicating whether the corresponding disk page (in the persistent memory) containing that object version entry also includes additional object versions. Thus, for example, as shown in FIG. 1B, object table entry 104A corresponds to Version 0 of Object A, which is stored in the persistent memory 150 at Disk Page A 152A. Additionally, entry 104A includes a single page flag portion 107 which may be used for indicating whether Version 0 of Object A is the only object version stored on Disk Page A. According to a specific implementation, the single page flag portion 107 may be set equal to “1” if the entirety of the associated object version (e.g. Version 0, Object A) is stored on a disk page (e.g. Disk Page A) in the persistent memory, and no other object version information is stored on that specific disk page.

It will be appreciated, however, that various modifications of the embodiment of FIG. 1B may be implemented by one having ordinary skill in the art. For example, in an alternate embodiment, the status flag bit in column 107 may be set to “0” to indicate that an object version is stored on a disk page in the persistent memory, and that no other object version information is stored on that specific disk page. Alternatively, a separate data structure may be used to keep track of disk page contents in a manner similar to that described above with respect to the disk page content information portion 107 of the Object Table 161.

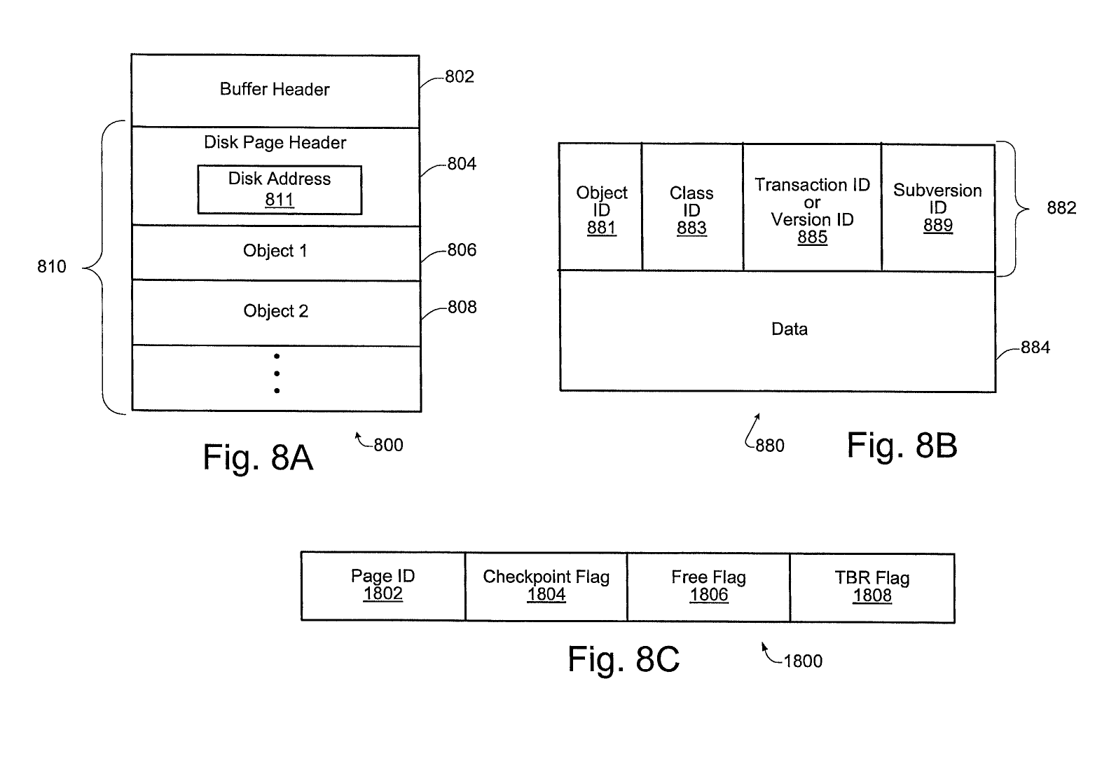

FIG. 8A shows a specific embodiment of a block diagram of a disk page buffer 800 which, for example, may correspond to the disk page buffer 111 of FIG. 1A. As shown in FIG. 8A, the disk page buffer 800 includes a buffer header portion 802 and a disk page portion 810. The disk page portion 810 includes a disk page header portion 804, and may include copies of one or more different object versions (e.g. 806, 808). According to a specific embodiment, the disk page header portion 804 includes a plurality of different fields, including, for example, a disk address field 81, which may be used for storing the address of the memory location where the corresponding disk page is stored in the persistent memory.

According to specific implementations, the disk page buffer 800 may be configured to include one or more disk pages 810. In the embodiment of FIG. 8A, the disk page buffer 800 has been configured to include only one disk page 810, which, according to specific implementations, may have an associated byte size of 4k or 8k bytes, for example.

FIG. 8B shows a block diagram of a version of a database object 880 in accordance with a specific embodiment of the present invention. According to a specific implementation, each of the object versions 806, 808 of FIG. 8A may be configured in accordance with the object version format shown in FIG. 8B.

Thus, for example, as shown in FIG. 8B, object 880 includes a header portion 882 and a data portion 884. The data portion 884 of the object 880 may be used for storing the actual data associated with that particular object version. The header portion includes a plurality of fields including, for example, an Object ID field 881, a Class ID field 883, a Transaction ID or Version ID field 885, a Sub-version ID field 889, etc. According to a specific implementation, the Object ID field 881 represents the logical ID associated with that particular object. Unlike conventional RDBMS systems which require that an Object Be identified by its physical address, the technique of the present invention allows objects to be identified and accessed using a logical identifier which need not correspond to the physical address of that object. In one embodiment, the Object ID may be configured as a 32-bit binary number.

The Class ID field 883 may be used to identify the particular class of the object. For example, a plurality of different object classes may be defined which include user-defined classes as well as internal structure classes (e.g., data pages, B-tree page, text page, transaction object, etc.).

The Version ID field 885 may be used to identify the particular version of the associated object. The Version ID field may also be used to identify whether the associated object version has been converted to a stable state. For example, according to a specific implementation, if the object version has not been converted to a stable state, field 885 will include a Transaction ID for that object version. In converting the object version to a stable state, the Transaction ID may be remapped to a Version ID, which is stored in the Version ID field 885.

Additionally, if desired, the object header 882 may also include a Subversion ID field 889. The subversion ID field may be used for identifying and/or accessing multiple copies of the same object version. According to a specific implementation, each of the fields 881, 883, 885, and 889 of FIG. 8B may be configured to have a length of 32 bits, for example.

According to specific embodiments, the data server cache may include at least one Allocation Map which may be used to store information relating to selected disk pages stored in the persistent memory. FIG. 8C shows a block diagram of an Allocation Map entry 1800 in accordance with a specific embodiment of the present invention. As shown in FIG. 18, each entry in the Allocation Map may include a Page ID field 1802, a Checkpoint Flag field 1804, a Free Flag field 1806, and a TBR Flag field 1808.

According to a specific embodiment, each entry in the Allocation Map may correspond to a particular disk page stored in the persistent memory. In one embodiment, a Page ID field 1802 may be used to identify a particular disk page residing in the persistent memory. In an alternate embodiment, the Page ID field may be omitted and the offset position of each Allocation Map entry may be used to identify a corresponding disk page in the persistent memory. In different implementations, the Page ID field may include a physical address or a logical address, either of which may be used for locating a particular disk page in the persistent memory.

The Checkpoint Flag field 1804 may be used to identify whether or not the particular disk page has been checkpointed. According to a specific embodiment, a “set” Checkpoint Flag may indicate that the disk page identified by the Page ID field has been checkpointed, and therefore that the data contained on that disk page is stable. However, if the Checkpoint Flag has not been “set”, then it may be assumed that the corresponding disk page (identified by the Page ID field) has not been checkpointed, and therefore that the data associated with that disk page is unstable.

The Free Flag field 1806 may be used to indicate whether the memory space allocated for the identified disk page is free to be used for storing other data. The TBR (or “To Be Released”) Flag field 1808 may be used to indicate whether the memory space allocated to the identified disk page is to be freed or released after a checkpointing operation has been performed. For example, if it is determined that a particular disk page in the persistent memory is to be dropped or discarded, the TBR Flag field in the entry of the Allocation Map corresponding to that particular disk page may be “set” to indicate that the memory space occupied by that disk page may be released or freed after a checkpoint operation has been completed. After a checkpointing operation has been completed, the Free Flag in the Allocation Map entry corresponding to the dropped disk page may then be “set” to indicate that the memory space previously allocated for that disk page is now free or available to be used for storing new data. According to a specific implementation, the Checkpoint Flag field 1084, Free Flag field 1806, and TBR Flag field 1808 may each be represented by a respective binary bit in the Allocation Map.

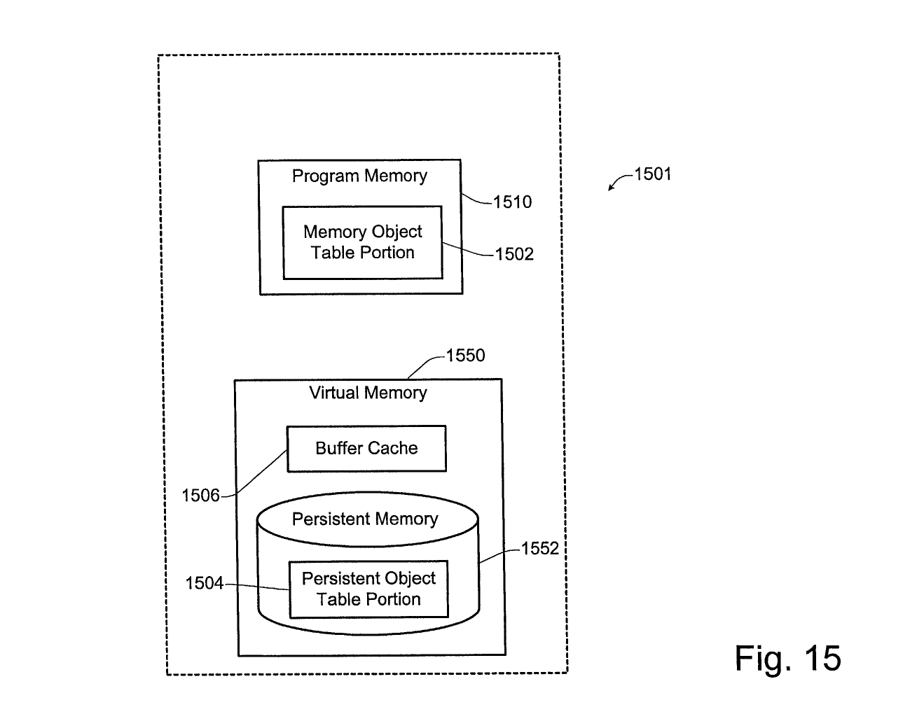

FIG. 15 shows a specific embodiment of a block diagram illustrating how different portions of the Object Table 1501 maybe stored within the information storage and retrieval system of the present invention. According to a specific implementation, Object Table 1501 may correspond to the Object Table 101 illustrated in FIG. 1A. As explained in greater detail below, a first portion 1502 (herein referred to as the Memory Object Table or MOT) of the Object Table 1501 may be located within volatile memory 1510, and a second portion 1504 (herein referred to as the Persistent Object Table or POT) of the Object Table 1501 may be located in virtual memory 1550. According to at least one implementation, volatile memory 1510 may include volatile memory (e.g., RAM), and virtual memory 1550 may include a memory cache 1506 as well as persistent memory 1504. According to a specific embodiment, portions of the Persistent Object Table (POT) 1504 may be stored as disk pages in the persistent memory 1552 and the buffer cache 1550. According to a specific implementation, when updates are made to portions of the Persistent Object Table, the updated portions are first created as pages in the buffer cache and then flushed to the persistent memory.

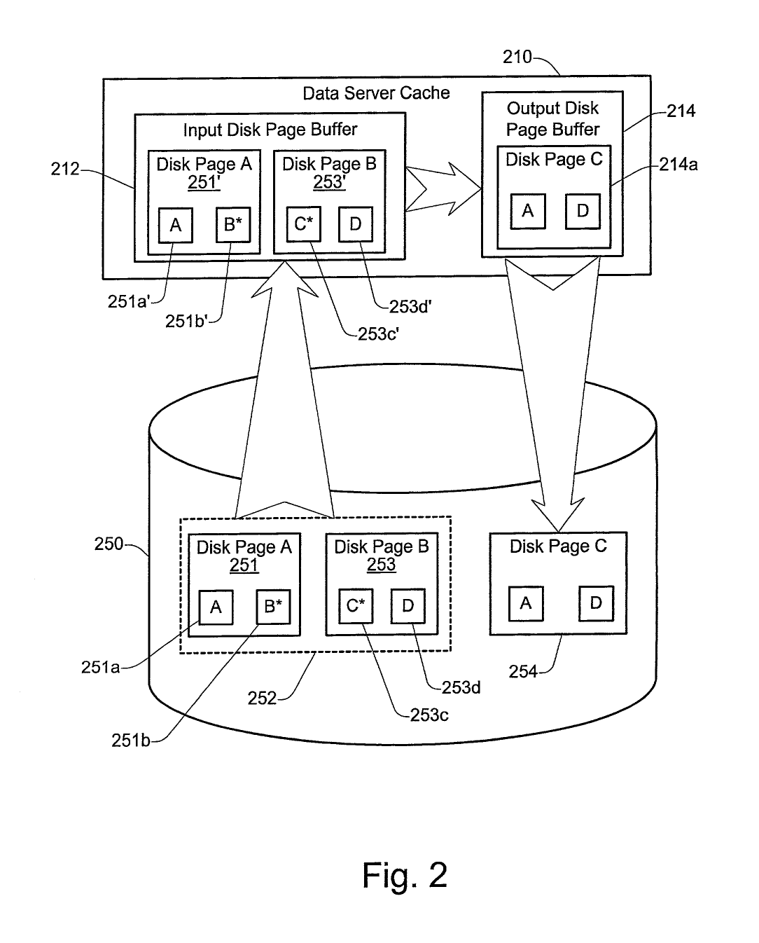

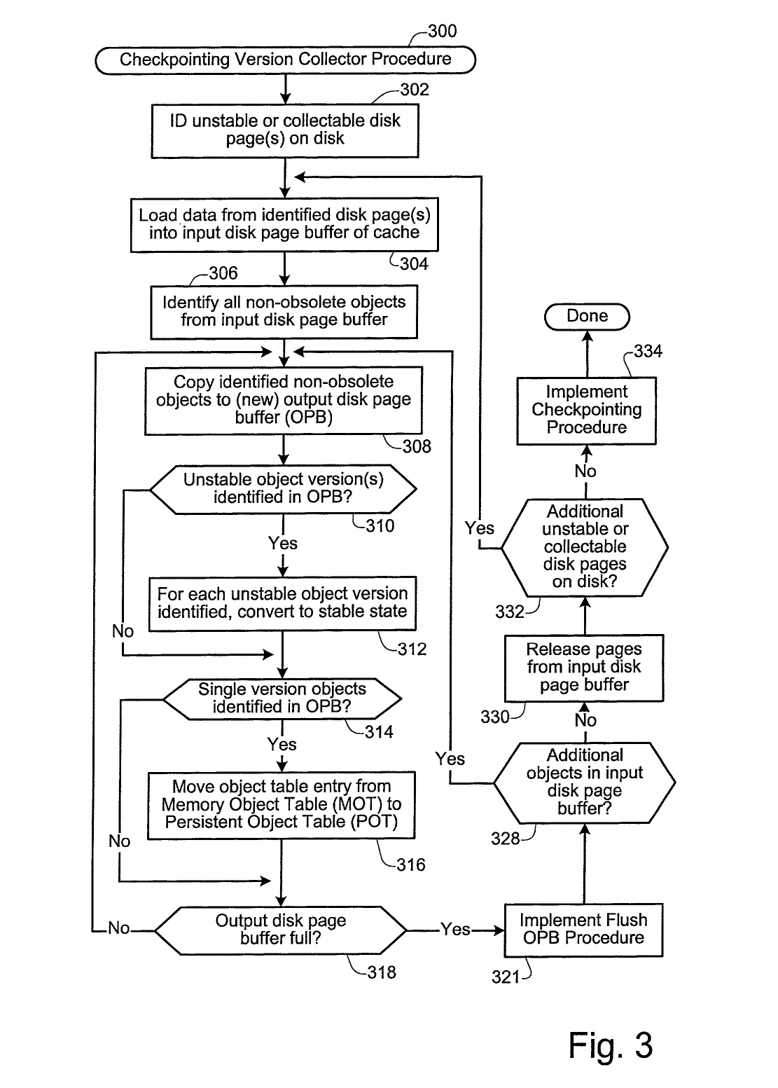

FIG. 2 shows a block diagram illustrating how an object version collection technique may be implemented in a specific embodiment of the database system of the present invention. An example of a specific embodiment of an object version collection procedure is illustrated in FIG. 3 of the drawings. More specifically, FIG. 3 describes a Checkpointing Version Collector Procedure similar to that described in FIG. 20A of the Parent Application.

As explained in greater detail below, the Checkpointing Version Collector Procedure 300 of FIG. 3 may be configured to perform a variety of functions such as, for example, identifying stable data in the persistent memory, identifying obsolete objects in the database, freeing memory which stores obsolete object versions, consolidating non-obsolete objects from old disk pages into new disk pages, etc.

According to a specific embodiment, the Checkpointing Version Collector Procedure 300 may be used to increase available storage space in the persistent memory, for example, by analyzing the data stored in the persistent memory, deleting obsolete objects, and/or consolidating non-obsolete objects into new disk pages. According to at least one implementation, the Checkpointing Version Collector Procedure may be initiated by a version collector manager. In one implementation, the Checkpointing Version Collector Procedure may be configured to run asynchronously with other processes or procedures described herein.

For purposes of illustration, it will be assumed that the Checkpointing Version Collector Procedure 300 has been implemented to perform version collection analysis on the data server 250 shown in FIG. 2. Initially, the Checkpointing Version Collector Procedure identifies (302) unstable or collectible disk pages stored in the persistent memory. According to a specific embodiment, an unstable or collectible disk page may be defined as one which includes at least one unstable or collectible object version. According to one implementation, an object version is not considered to be “collectible” if (1) it is the most recent version of that object, or (2) it is currently being used or accessed by any user or application.

In the example of FIG. 2, disk pages 251 and 253 represent collectible disk pages in the persistent memory. In this example, each obsolete object may be identified as a box which includes an asterisk “*”. Thus, for example, Disk Page A 251 includes a first non-obsolete Object Version A (251a) and a second, obsolete Object Version B (251b). Disk Page B also includes one obsolete Object Version C (253c) and one non-obsolete Object Version D (253d).

As shown at 304 of FIG. 3, copies of the identified unstable or collectible disk pages are loaded into one or more input disk page buffers of the data server cache. Thus, for example, as shown in FIG. 2, copies of disk pages 251 and 253 are loaded into input disk page buffer 212 of the data server cache 210.

According to a specific embodiment, the input disk page buffer 212 may be configured to store information relating to a plurality of disk pages which have been copied from the persistent memory 250. For example, in one implementation, the input disk page buffer 212 may be configured to store up to 32 disk pages of 8 kilobytes each. Thus, for example, after the Checkpointing Version Collector Procedure has loaded 32 disk pages from the disk into the input disk page buffer, it may then proceed to analyze each of the loaded disk pages for version collection. Alternatively, a plurality of input disk page buffers may be provided in the data server cache for storing a plurality of unstable or collectible disk pages.

The Checkpointing Version Collector Procedure then identifies (306) all non-obsolete object versions in the input disk page buffer(s). According to one embodiment, the Object Table may be referenced for determining whether a particular object version is obsolete. According to one implementation, an object version may be considered obsolete if it is not the newest version of that object and it is also collectible. Additionally, according to a specific embodiment, an obsolete object version may be identified as an object version which is stored in the persistent memory, and does not have a corresponding entry in the Object Table. In the example of FIG. 2, it is assumed that Object B (251b′) and Object C (253c′) of the input disk page buffer 212 are obsolete.

As shown at 308, all identified non-obsolete object versions are copied from the input disk page buffer(s) to one or more output disk page buffers. In the example of FIG. 2, it is assumed that Object Versions A and D (253a′, 253d′) are both non-obsolete, and are therefore copied (308) from the input disk page buffer 212 to the output disk page buffer 214. According to a specific embodiment, a plurality of output disk page buffers may be used for implementing the Checkpointing Version Collector Procedure of the present invention. For example, when a particular output page buffer becomes full, a new output disk page buffer may be created to store additional object versions to be copied from the input page buffer(s). In a specific embodiment, each output disk page buffer may be configured to store one 8-kilobyte disk page.

At 310 a determination is made as to whether one or more object versions in the output disk page buffer(s) are unstable. According to a specific embodiment, an unstable object version is one which has not been assigned a Version ID. Thus, for example, if a selected object version in the output disk page buffer 214 has an associated Transaction ID, it may be considered to be an unstable object version. If it is determined (310) that a selected object version of the output disk page buffer(s) is unstable, then the selected object version may be converted (312) to a stable state. According to a specific embodiment, this may be accomplished by remapping the Transaction ID associated with the selected object version to a respective Version ID.

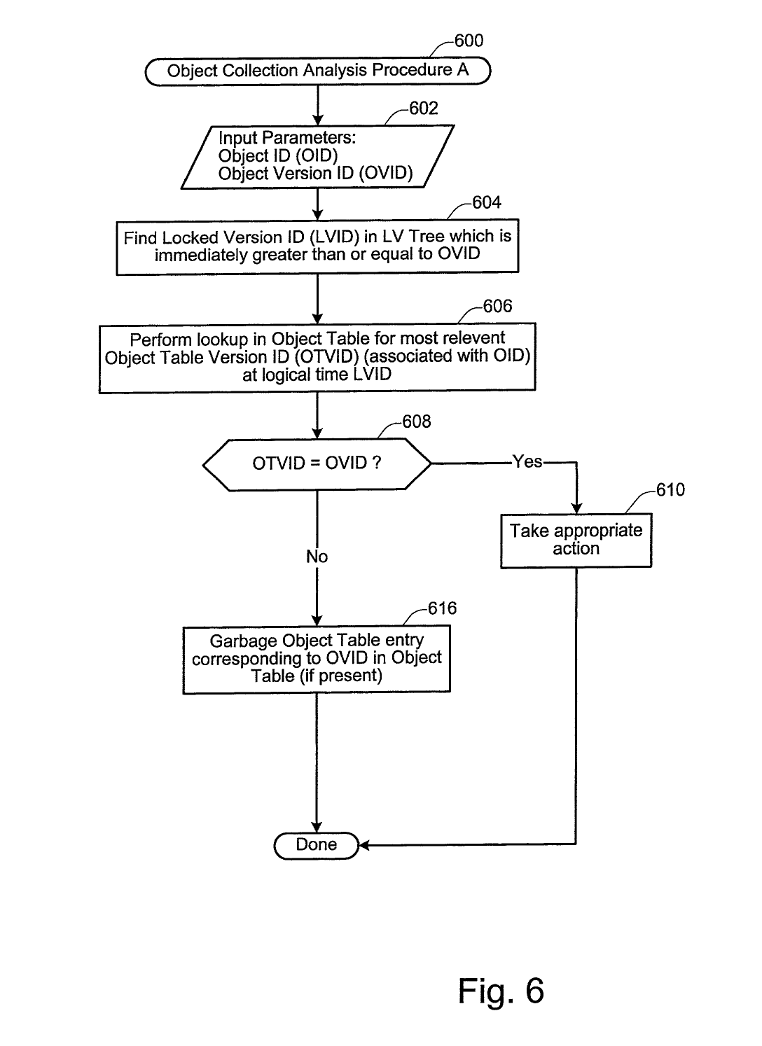

At 314 a determination is made as to whether any single object versions have been identified in the output disk page buffer(s). According to a specific embodiment, for each single object version identified in the output disk page buffer 214, the Object Table entry corresponding to the identified single object version is moved (316) from the Memory Object Table to the Persistent Object Table. This aspect has been described previously with respect to FIG. 6 of the Parent Application.

At 318 a determination is made as to whether the output disk page buffer 214 has become full. According to a specific implementation, the output disk page buffer 214 may be configured to store a maximum of 8 kilobytes of data. If it is determined that the output disk page buffer is not full, additional non-obsolete object data may be copied from the input disk page buffer to the output disk page buffer and analyzed for version collection.

When it is determined that the output disk page buffer has become full, then the disk page portion of the output disk page buffer may be flushed (321) to the persistent memory. In the example of FIG. 2, the disk page portion 214a of the output disk page buffer 214 is flushed to the persistent memory 250 as by Disk Page C 254. According to a specific embodiment, the VC Manager may implement a Flush Output Disk Page Buffer (OPB) Procedure to thereby cause the disk page portion of the output disk page buffer 214 to be flushed to the persistent memory 250. An example of a Flush Output Disk Page Buffer Procedure is described with respect to FIG. 20B of the Parent Application. During this procedure, contents of the output disk page buffer may be written to a new disk page (e.g. 1954) in the persistent memory, and the information stored is appropriate old disk page(s) (e.g. 1952) may be released. Additionally, according to a specific embodiment, checkpointing of various data stored in the information and retrieval system of the present invention may also be performed.

According to a specific embodiment, after a particular output disk page buffer has been flushed to the persistent memory, that particular output disk page buffer may continue to reside in the data server cache (if desired). At that point, the cached disk page (e.g. 214a) may serve as a working copy of the corresponding disk page (e.g. 254) stored in the persistent memory.

As shown at 328 of FIG. 3, a determination is then made as to whether there are additional objects in the input disk page buffer to be analyzed for version collection. If it is determined that there are additional objects in the input disk page buffer to be analyzed for version collection, a desired portion of the additional object data may then be copied from the input disk page buffer to a new output disk page buffer (not shown in FIG. 2). Thereafter, the Checkpointing Version Collector Procedure may then analyze the new output disk page buffer data for version collection and checkpointing.

Upon determining that there are no additional objects in the input disk page buffer(s) to be analyzed for version collection, the disk pages that were loaded into the input disk page buffer(s) may then be released (330) from the data server cache. Thereafter, a determination is made (332) as to whether there are additional unstable or collectible disk pages in the persistent memory which have not yet been analyzed for version collection using the Checkpointing Version Collector Procedure. If it is determined that there are additional unstable or collectible pages in the persistent memory to be analyzed for version collection, at least a portion of the additional disk pages are loaded into the input disk page buffer of the data server cache and subsequently analyzed for version collection.

According to a specific implementation, a separate thread of the Checkpointing Version Collector Procedure may be implemented for each disk which forms part of the persistent memory of the information storage and retrieval system of the present invention. Accordingly, it will be appreciated that, in embodiments where a persistent memory includes multiple disk drives or other memory storage devices, separate threads of the Checkpointing Version Collector Procedure may be implemented simultaneously for each respective disk drive, thereby substantially reducing the amount of time it takes to perform a checkpointing operation for the entire persistent memory data set.

As shown at 334 of FIG. 3, after the Checkpointing Version Collector Procedure has analyzed all of the unstable and collectible disk pages of all or a selected portion of the persistent memory, a checkpointing procedure may then be implemented (334). An example of a Checkpointing Procedure is illustrated and described in greater detail in the Parent Application.

According to alternate embodiments of the present invention, object version collection may also be implemented without performing checkpointing related operations.

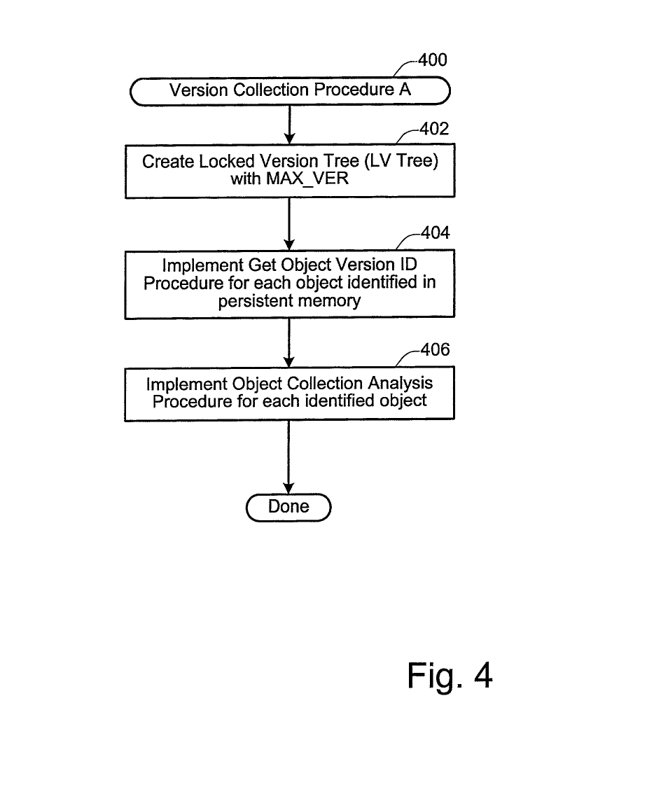

FIG. 4 shows a flow diagram of a Version Collection Procedure A 400 in accordance with an alternate embodiment of the present invention. It will be appreciated from the discussion below that there may exist some overlap between the version collection procedures described in FIGS. 3 and 4. For example, in one implementation, at least a portion of the procedural operations described in FIG. 4 may be implemented during operations 302-306 of FIG. 3.

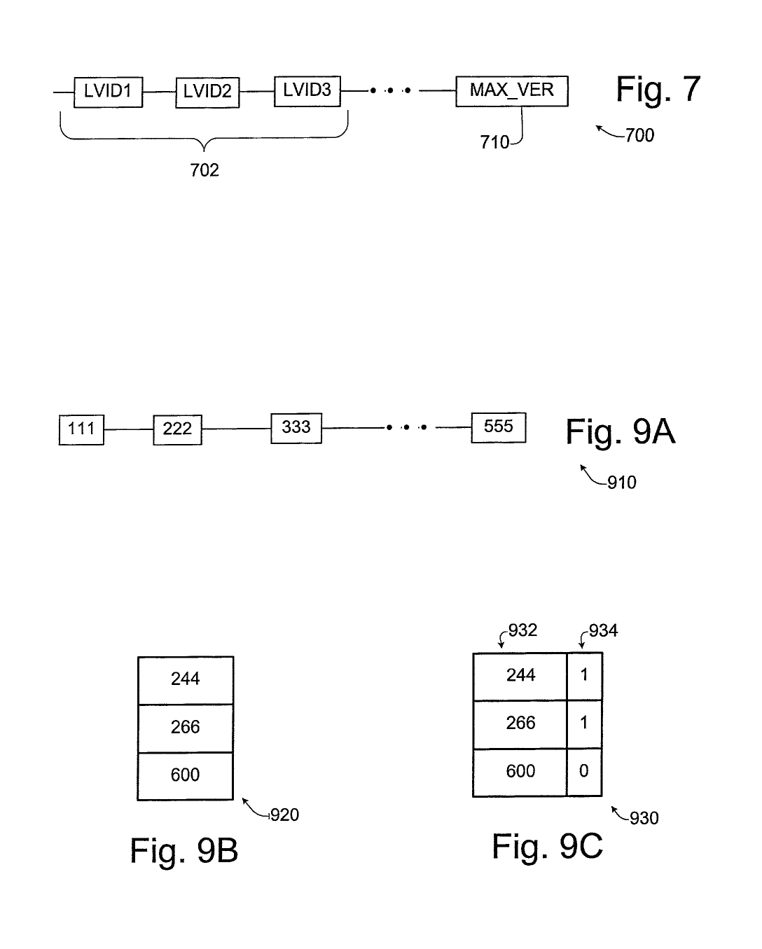

For purposes of describing the Version Collection Procedure 400 of FIG. 4, it is assumed that object version collection will be performed by accessing disk page information stored in the persistent memory. Initially, as shown at 402, a locked version tree (LV Tree) may be created for use in identifying specific object versions which are currently locked or uncollectible. According to different embodiments, the LV Tree may be implemented as a list, a tree, or other sortable data structure which may be used for storing version ID information. An example of an LV Tree is illustrated in FIG. 7 of the drawings.

FIG. 7 shows a block diagram of a locked version tree (LV Tree) or list 700, in accordance with a specific embodiment of the present invention. As shown in FIG. 7, the LV Tree 700 may include a plurality of entries 702 corresponding to specific object version IDs residing in the database which are currently uncollectible or locked. According to specific embodiments, there may be a number of different techniques used for marking one or more selected object versions as being uncollectible. For example, one or more object versions may be explicitly saved as uncollectible (e.g. either manually or automatically). For example, a banking system implementing the information storage and retrieval technique of the present invention may desire to save a transaction history (e.g. selected object versions) which have occurred within the past 30 days. Alternatively, an object version may be identified as being uncollectible if that object version is currently being accessed by a user and/or process. According to a specific implementation, a specific object version which is currently being accessed by a process may be flagged as being uncollectible, and the version ID corresponding to that object version may be stored within the LV Tree at a location relative to the other version ID values stored therein. After the user or process has finished accessing the specified object version, or, alternatively, after the process has expired, the entry in the LV Tree corresponding to the selected object version may be removed, and the selected object version be made available for version collection analysis. According to a specific embodiment, the contents of the LV Tree may be managed by a version collection manager such as that described in the Parent Application.

Additionally, as show in FIG. 7, the LV Tree 700 may also include a MAX_VER entry 710 which, according to a specific embodiment, may be used to represent the most recent transaction which was committed to the persistent memory at the start of a version collector analysis procedure. This feature is described in greater detail below.

FIG. 9A shows an example of an LV Tree 910 which may be used to illustrate various aspects of the present invention. As shown in FIG. 9A, the LV Tree 910 includes at least four entries. Each entry represents a specific locked version ID (LV ID). In the present example, it is assumed that the database includes three uncollectible object versions, namely, object versions corresponding to version IDs 111, 222, and 333. It is to be noted that these three version IDs do not necessarily correspond to different versions of the same object. Additionally, in the present example, it is assumed that the most recent transaction which was committed to persistent memory at the start of the Version Collection Procedure 400 was the Version ID 555, which corresponds to the MAX_VER value. According to a specific embodiment, the MAX_VER value is appended to the LV Tree at the start of a version collection procedure.

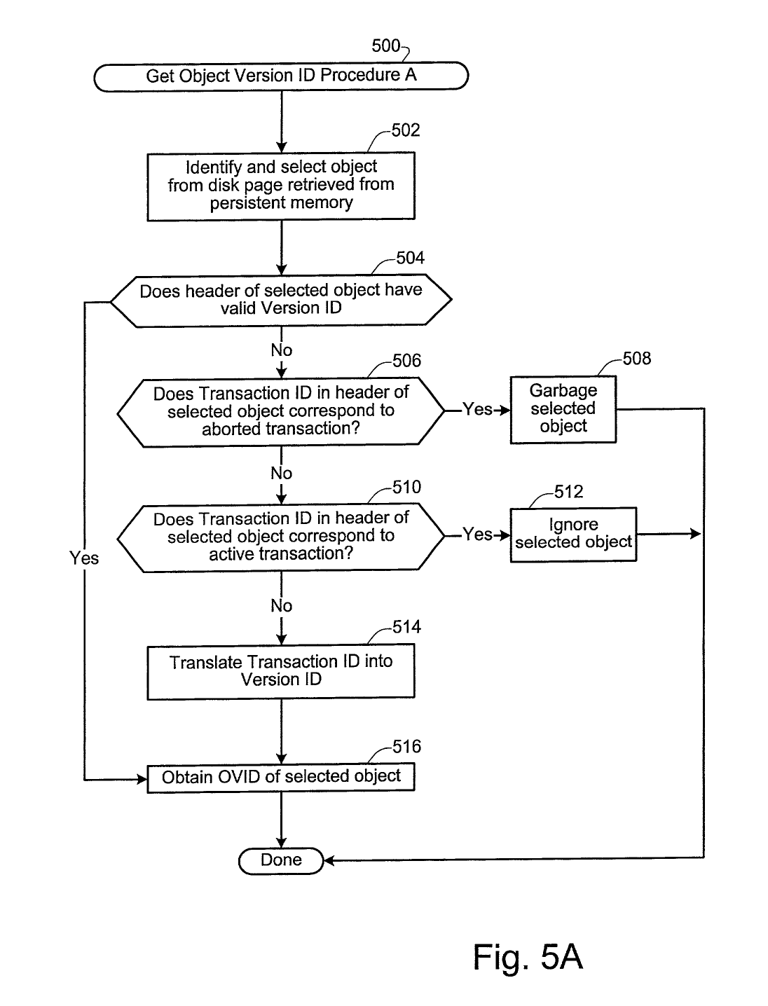

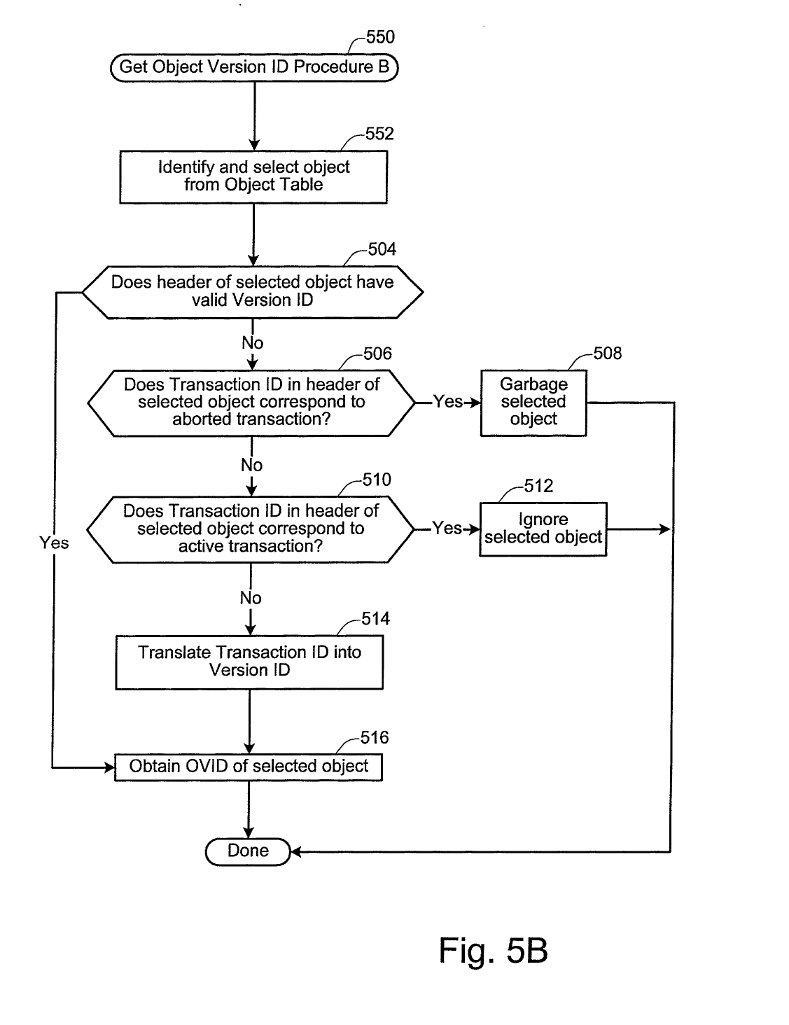

Returning to FIG. 4, it is assumed that, for purposes of illustration, the LV Tree 910 (which includes entry 111, 222, and 333) is created at 402. During this operation, the MAX_VER value (e.g. 555) is appended to the LV Tree. Once the LV Tree has been created, a Get Object Version ID Procedure may be implemented (404) for each object identified in the persistent memory. An example, of a Get Object Version ID Procedure is illustrated in FIG. 5A of the drawings, which is described in greater detail below.

According to a specific embodiment, one function of the Get Object Version ID Procedure is to obtain, if possible, valid object version IDs for selected objects residing in the database. After the object version IDs have been obtained for selected objects identified in the persistent memory, an object collection analysis procedure may be implemented (406) for each of the identified objects in order to determine, for example, whether any of the identified object versions are collectible. An example of an object collection analysis procedure is illustrated in FIG. 6 of the drawings, and described in greater detail below.

FIG. 5A shows a flow diagram of Get Object Version ID Procedure A 500 in accordance with a specific embodiment of the present invention. According to a specific embodiment, one function of the Get Object Version ID Procedure is to determine whether a selected object has a valid version ID, and if so, to obtain the object version ID for the selected object. According to one implementation, the Get Object Version ID Procedure may be implemented by a VC Manager such as that, described, for example, in the Parent Application.

Initially, as shown at 502, a selected object in the database which is a potential candidate for version collection is identified. According to a specific embodiment, the identification of objects for version collection may be performed by identifying unstable or collectible disk pages in the persistent memory, loading data from the identified disk pages into volatile memory, and selecting objects from the disk pages loaded into the volatile memory for version collection analysis. This process has been described previously with respect to FIGS. 2 and 3 of the drawings. An alternate technique for selecting objects for version collection analysis may be implemented by identifying object versions from the Object Table stored in the volatile memory. This latter technique is described in greater detail below, for example, with respect to FIG. 5B of the drawings.

Once a particular object version has been identified and selected for analysis, the header of the selected object version is checked (504) in order to determine whether the header portion of the selected object contains a valid object version ID (OVID). If it is determined that the header does contain a valid OVID, then the OVID value is obtained (516).

However, if it is determined that the header portion of the selected object does not contain a valid version ID, then, according to a specific embodiment, it may be assumed that the header of the selected object contains a transaction ID. Accordingly, a determination may then be made (506) as to whether the transaction ID in the header of the selected object corresponds to an aborted transaction. If so, the selected object may be garbaged or deleted (508) from the database. According to specific implementations, a selected object may be garbaged or deleted from the database by performing one or more operations such as, for example, deleting the object table entry corresponding to the selected object from the Object Table; erasing the selected object from the persistent memory; changing the status of the memory location(s) (in the persistent memory) where the selected object is stored so as to allow new data to be stored in those memory location(s); etc.

Assuming that the transaction ID in the header of the selected object does not correspond to an aborted transaction, a determination may then be made (510) as to whether the transaction ID corresponds to an active transaction. According to one implementation, an active transaction may be characterized as a transaction which is currently in progress. If it is determined that the transaction ID corresponds to an active transaction, then the selected object may be ignored (512) for purposes of version collection.

If it is determined that the transaction ID associated with the selected object does not correspond to an aborted transaction, and further does not correspond to an active transaction, then, according to a specific embodiment, it may be assumed that the transaction ID corresponds to a completed transaction. Accordingly, the transaction ID may then be translated (514) into a valid version ID in order to obtain (516) an OVID for the selected object. According to a specific embodiment, the translation of a transaction ID into a version ID may be implemented by using a transaction table which maps transaction IDs to version IDs.

According to a specific embodiment, once the object version ID (OVID) for the selected object has been obtained an object collection analysis procedure may be implemented for the identified object, where upon the OVID of the identified object may then be passed as an input parameter to the object collection analysis procedure. An example of an object collection analysis procedure is shown, for example, in FIG. 6 of the drawings.

FIG. 6 shows a flow diagram of an Object Collection Analysis Procedure A 600 in accordance with a specific embodiment of the present invention. According to at least one embodiment, the Object Collection Analysis Procedure may be used to identify obsolete, collectible and/or non-collectible objects in the database in order, for example, to reduce the number of persistent memory access operations implemented subsequently by a version collection procedure. In one implementation, the Object Collection Analysis Procedure may be implemented by the VC Manager described in the Parent Application.

Initially, as shown at 602, the Object Collection Analysis Procedure 600 may receive one or more input parameters relating to one or more objects selected for version collection analysis. As shown in the embodiment of FIG. 6, such input parameters may include, for example, an object ID (OID) associated with a selected object, and an object version ID (OVID) associated with the selected object. For purposes of illustration, it will be assumed that the object version ID corresponding to a particular object which has been selected for version collection analysis corresponds to the value OVID=244, and that the object ID value of the selected object version is OID=199.

At 604 the LV Tree (e.g. 910) is consulted in order to identify an appropriate LVID entry which is immediately greater than or equal to the OVID of the selected object. Thus, according to a specific embodiment, the LV Tree is searched for an LVID entry whose value is as close as possible to the OVID value, and is also greater than or equal to the OVID value.

For purposes of illustration, it will be assumed that the LV Tree of the present example corresponds to the LV Tree 910 of FIG. 9A. Since the OVID value of the selected object is equal to 244, the LV Tree 910 is consulted to locate a locked version ID (LVID) entry which is either equal to 244, or greater than and as close as possible to the value 244. In the present example, the result of the selection criteria expressed in operation 604 will be the identification and selection of LVID=333 from the LV Tree 910.

Once the appropriate LVID value has been identified, an object table lookup may be performed (606) in order to find the most relevant object table version ID (OTVID) (corresponding to the OID of the selected object, e.g. OID=199) at a logical time value corresponding to the LVIID value. According to a specific embodiment, the most relevant object table version ID at a logical time value T corresponds to the Object Table entry having an associated OTVID value which is immediately less than or equal to the time value T.

For purposes of illustration, it will be assumed in the present example that the Object Table includes a plurality of entries for object versions associated OID=199, as illustrated, for example, in FIG. 9B of the drawings.

FIG. 9B shows a portion of an object table 920 in accordance with a specific embodiment the present invention. As illustrated in the example of FIG. 9B, object table portion 920 includes three object version IDs associated with OID=199.

In applying the criteria of operation 606 (FIG. 6) to the example of FIG. 9B, a lookup is performed for the most relevant object table version ID for LVID=333. In the present example, the result of the lookup operation will be the identification of OTVID=266 since, according to the example of FIG. 9B, the value 266 is the closest value which is immediately less than or equal to LVID=333.

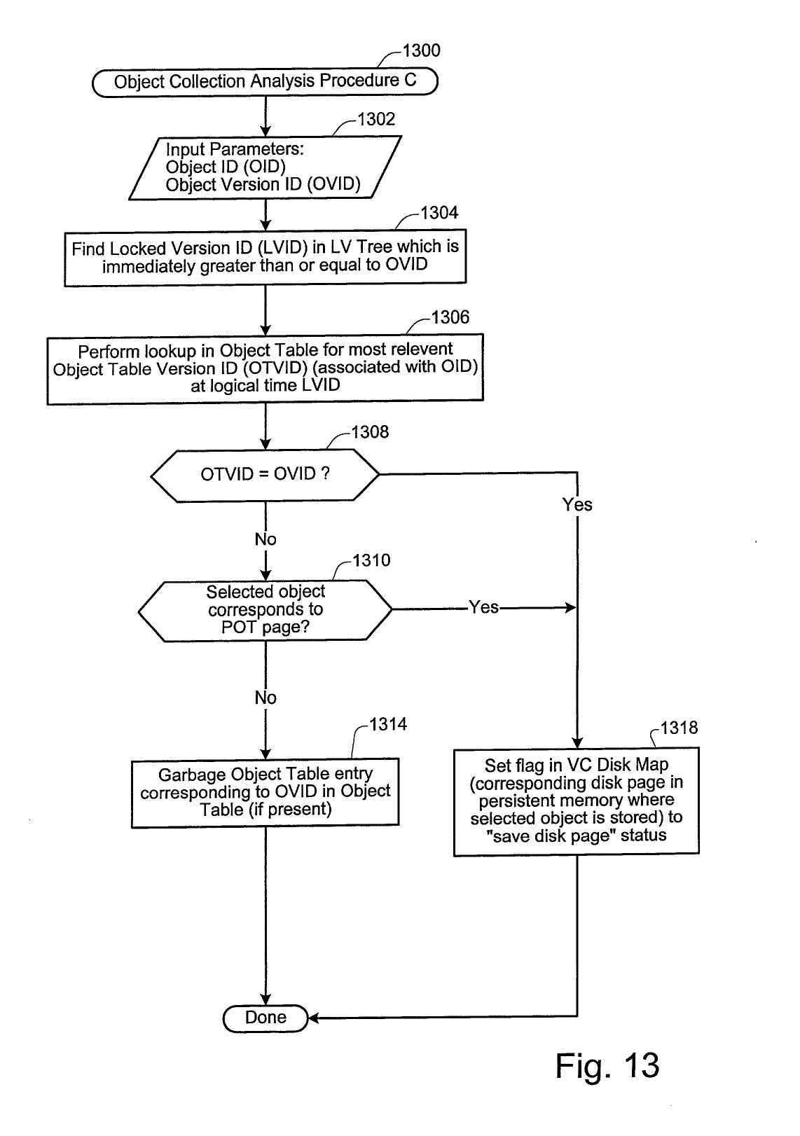

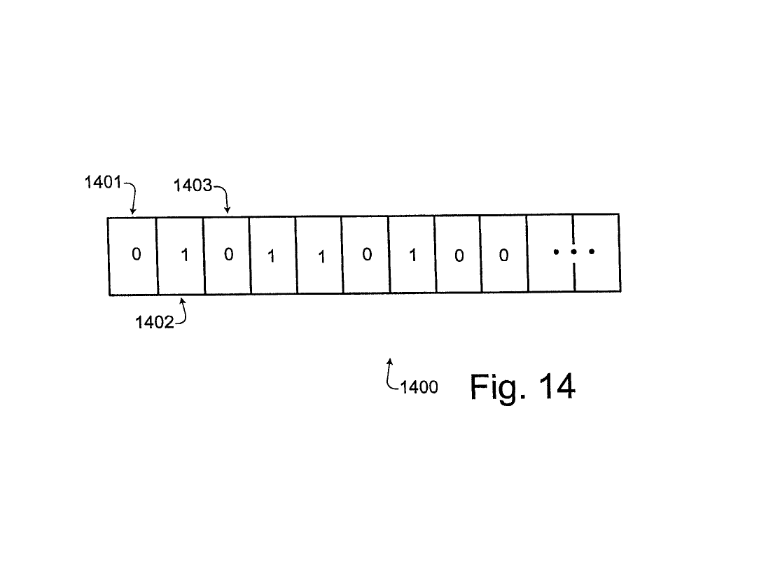

Once the appropriate OTVID value has been obtained during the object table lookup operation at 606, a determination may then be made (608) as to whether the OTVID value is equal to the OVID value. If it is determined that the OTVID value is the same as the OVID value, then it may be concluded that the currently selected object version is not to be collected or garbaged. Accordingly, appropriate action may be taken based upon this determination. For example, the selected object version may be ignored for purposes of version collection. Alternatively, at least one status flag associated with the selected object version may be set to indicate that the selected object version is a non-collectible object version. For example, appropriate information may be stored in a VC Disk Map (described in greater detail with respect to FIGS. 13-14) to indicate that the disk page (in the persistent memory) which stores the selected object version is not to be garbaged for purposes of version collection. According to a specific embodiment, the version collection procedure may subsequently use this information in order to avoid unnecessary operations and/or to reduce the number of persistent memory access operations performed.

If, however, it is determined at 608 that the OTVID value is not equal to the OVID value, then, according to a specific embodiment, it may be concluded that the currently selected object version corresponds to an obsolete object version. Accordingly, the Object Table entry corresponding to the OVID may be garbaged or deleted (616), if present.

In the present example, since the value of OTVID=266 is not equal to the value of OVID=244, the Object Table entry corresponding to OTVID=244 (if present) will be garbaged (616) from the Object Table. Thereafter, when a version collection procedure (such as that described, for example, in FIG. 3 of the drawings) is implemented, the obsolete object version may be quickly identified (e.g. since there is no corresponding entry in the Object Table) and deleted from the persistent memory.

As explained in greater detail below, different embodiments of the version collection procedure may be implemented wherein at least a portion of the object versions which are analyzed for version collection analysis may be identified using information stored in the Object Table (residing in the volatile memory) rather than using information from object headers stored in the persistent memory. In this way, the number of disk access operations performed during the version collection operations may be significantly reduced or eliminated.

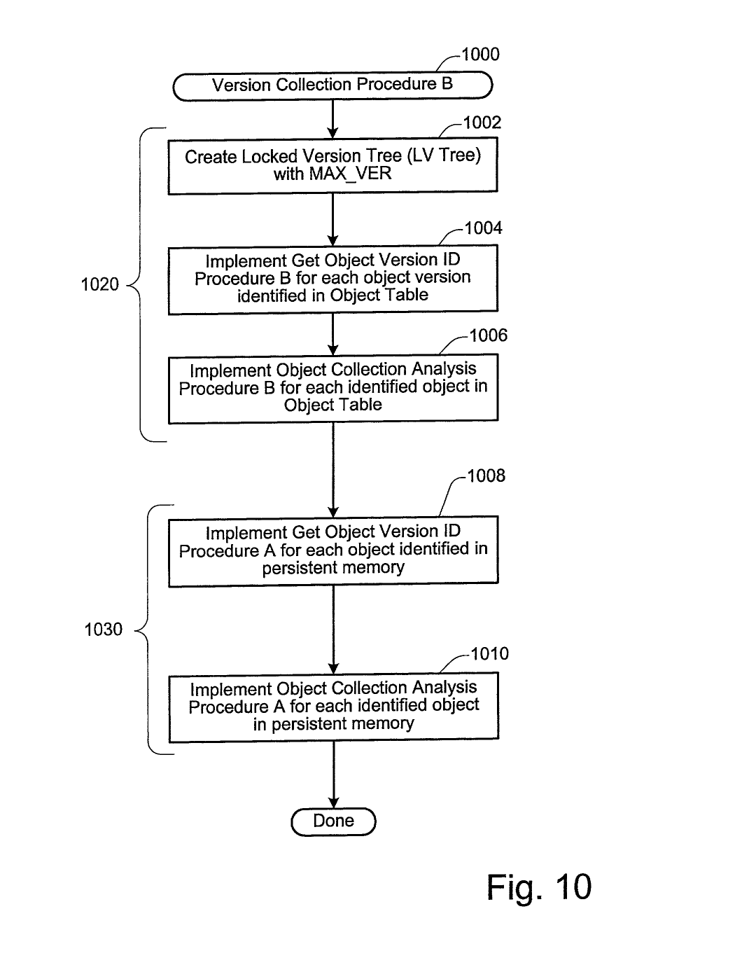

FIG. 10 shows an alternate embodiment of a Version Collection Analysis Procedure B 1000 in accordance with a specific embodiment of the present invention. As explained in greater detail below, the Version Collection Procedure 1000 may significantly reduce or eliminate the number of disk access operations performed during the version collection operations by identifying obsolete object versions using information stored in the Object Table. For example, according to a specific embodiment, if an obsolete object version is identified, and it is determined that the identified obsolete object is stored on a single disk page in the persistent memory, and that the identified obsolete object version is the only object version be stored on the identified disk page, then the identified obsolete object may be garbaged by freeing the identified disk page in the persistent memory without ever having to perform a disk access operation to retrieve the contents of the identified disk page.

As shown in the embodiment of FIG. 10, a first portion 1020 of the version collection procedure performs version collection analysis of at least a portion of database objects without performing disk access operations to retrieve the object version information from the persistent memory. After the first portion 1020 of the Version Collection Procedure B has been completed, a second portion 1030 of the Version Collection Procedure B may be implemented in a manner similar to that described in FIGS. 5A and 6.

According to a specific embodiment, the second portion 1030 of the Version Collection Procedure B will perform version collection analysis on database objects which were not analyzed during the first portion 1020 of the version collection procedure B. For example, since the first portion 1020 of the Version Collection Procedure B may garbage at least a portion of obsolete object versions in the persistent memory, the garbaged object versions will not be available for version collection analysis by the second portion 1030 of the version collection procedure. Thus, according to one implementation, the second portion 1030 of the Version Collection Procedure B will perform version collection analysis only database objects which were not analyzed during the first portion 1020 of the version collection procedure B.

Initially, as shown at 1002, a locked version tree is created with the MAX_VER value appended to it. At 1004, a Get Object Version ID Procedure is implemented for each object version identified in the Object Table. An example of a Get Object Version ID Procedure is illustrated in FIG. 5B of the drawings.

FIG. 5B shows an alternate embodiment of a Get Object Version ID Procedure 550 in accordance with a specific embodiment of the present invention. In the embodiment of FIG. 5B, one or more object versions which are selected for version collection analysis are identified from information in the Object Table rather than from information retrieved from the persistent memory. In this way, the number of disk access operations performed during the Get Object Version ID Procedure 550 may be significantly reduced, or avoided altogether.

Thus, as shown in FIG. 5B, at least one object version may be identified and selected (552) for version collection analysis from the Object Table entries illustrated, for example, in Object Table 161 of FIG. 1B. Once a particular object version has been selected for version collection analysis, the a Get Object Version ID Procedure 550 proceeds to obtain the object version ID (OVID) of the selected object version in a manner similar to that described previously with respect to operations 504 through 516 of FIG. 5A.

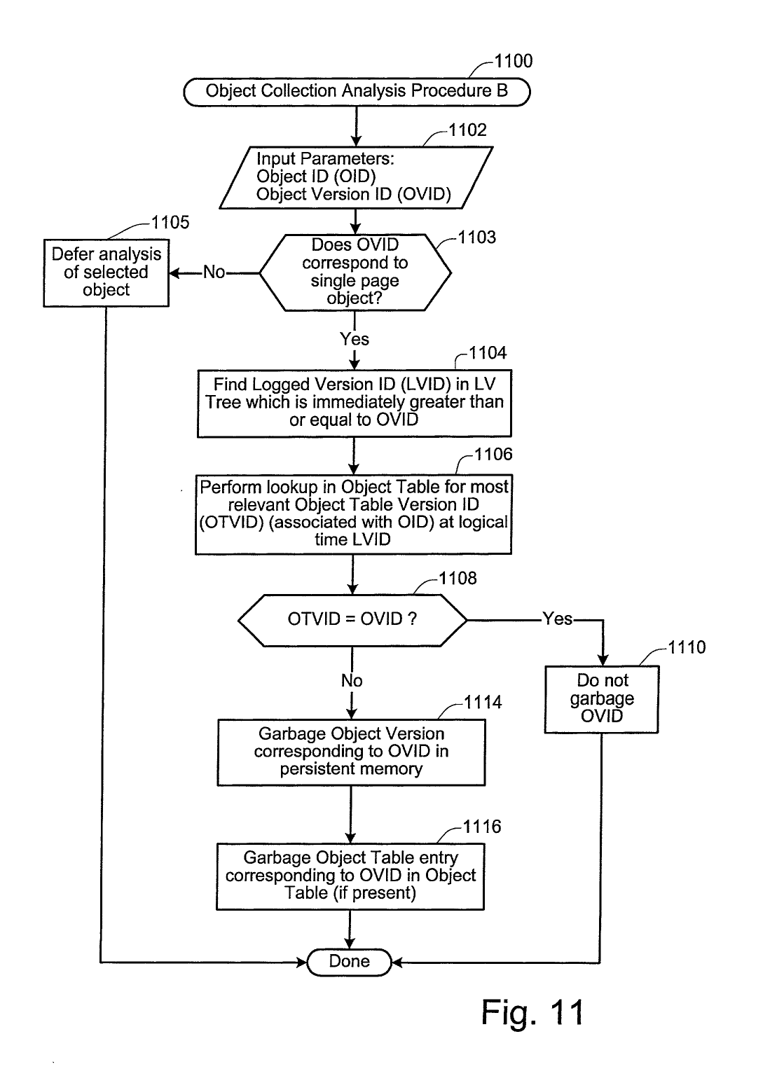

Returning to FIG. 10, after the object version ID of a selected database object has been obtained, an Object Collection Analysis Procedure may be implemented (1006) in order to determine whether the selected object corresponds to an obsolete object version which is to be garbaged during the version collection procedure. According to a specific implementation, an Object Collection Analysis Procedure such as that shown, for example, in FIG. 11, may be implemented for each object identified in the Object Table.

FIG. 11 shows a flow diagram of an Object Collection Analysis Procedure B 1100 in accordance with a specific embodiment of the present invention. In the Object Collection Analysis Procedure B of FIG. 11, it is assumed that object versions which are to be analyzed for purposes of version collection have been identified and selected using information in the Object Table. Additionally, in the embodiment of FIG. 11, it is further assumed that the Object Table corresponds to the embodiment of the Object Table 161 illustrated, for example, in FIG. 1B.

Initially, as shown at 1102, the Object Collection Analysis Procedure B receives input parameters such as, for example, an OID value and, and an OVID value for a selected object. A determination is then made (1103) as to whether the selected object version (corresponding to the specified OVID) is stored as a single disk page in the persistent memory. According to a specific implementation, this determination may be made by checking the value of the single page flag bit field 107 corresponding to the identified object version entry in the Object Table 161.

If it is determined that the identified object version is not stored as single disk page in the persistent memory, then further version collection analysis of the selected object version may be deferred (1105), at least temporarily until the second portion 1030 of the Version Collection Procedure B is implemented. Thus, for example, if portions of the selected object version are stored on several disk pages in the persistent memory, or if the selected object version is stored on a particular disk page in the persistent memory along with other object versions which are stored on that disk page, version collection analysis of the selected object version may be deferred until the second portion 1030 of the Version Collection Procedure B is implemented.

If, however, it is determined that the selected object version is stored as single disk page in the persistent memory, then the Object Collection Analysis Procedure B may continue analyzing the selected object version for version collection as described in operations 1104 through 1116. It will be appreciated that the operations 1104 through 1116 of FIG. 11 are substantially similar to FIG. operations 604 through 616 described previously with respect to FIG. 6, and therefore will not presently be described in greater detail.

Returning to FIG. 10, after the first portion 1020 of the Version Collection Procedure B has been completed, all obsolete single disk page objects will preferably have been removed or deleted from the database. Thereafter, the second portion 1030 of the Version Collection Procedure B may be implemented in order to perform version collection analysis on the remaining database objects in the persistent memory. More specifically, as shown at 1008, a Get Object Version ID Procedure such as that illustrated in FIG. 5A may be implemented for each object identified in the persistent memory. Thereafter, the Object Collection Analysis Procedure A (FIG. 6) may be implemented for each identified object in the persistent memory.

It will be appreciated that the overall execution time of the Version Collection Procedure B may be significantly less than the overall execution time of the Version Collection Procedure A since, according to a specific embodiment, obsolete object versions which are stored in the persistent memory as a single disk page may be identified and analyzed for purposes of version collection without having to perform disk access operation to retrieve contents of the disk page (e.g. a copy of the obsolete object version) into working memory. Moreover, the greater the number of object versions which are stored in the persistent memory as single disk pages in the persistent memory, the faster the Version Collection Procedure B will be completed. For example, in implementations where about half of the database objects are stored in the persistent memory as single disk pages, the overall execution time of the Version Collection Procedure B may be reduced by several orders of magnitude compared to that of Version Collection Procedure A.

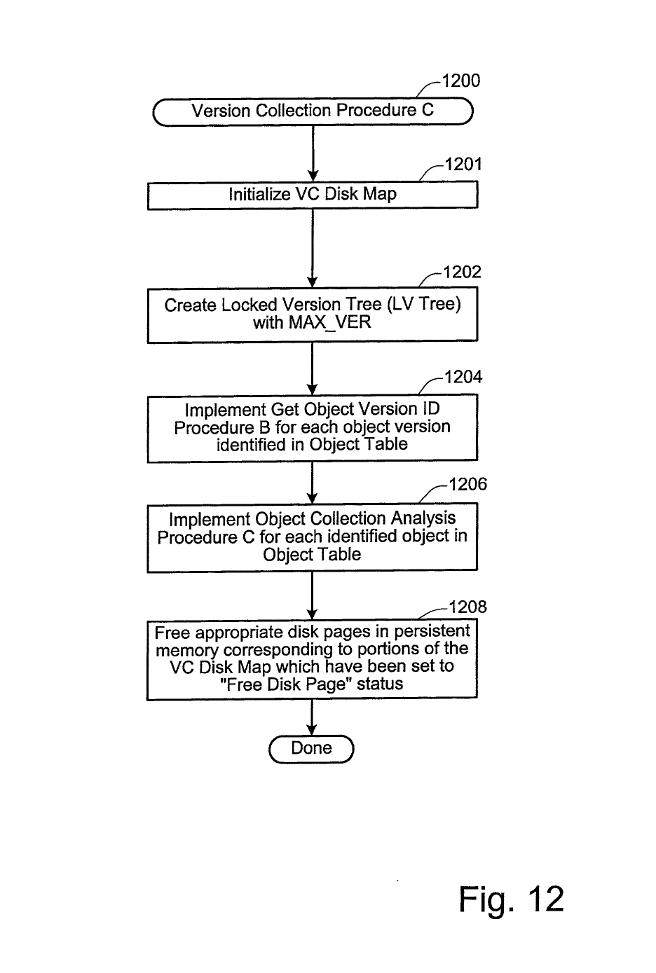

FIG. 12 shows an alternate embodiment of a Version Collection Procedure C 1200 in accordance with a specific embodiment of the present invention. According to a specific embodiment, the Version Collection Procedure C of FIG. 12 offers an even greater reduction in the overall execution time of the version collection process as compared to the Version Collection Procedure A or B.

More specifically, according to a specific embodiment, the Version Collection Procedure C may be implemented to perform version collection analysis of objects stored in the database without performing any disk access operations in order to retrieve object version information from the persistent memory for the purpose of version collection analysis.

A specific embodiment of POT page collection is described in the Parent Application. According to an alternate embodiment, however, obsolete persistent object table pages may also be collected using the improved version collection technique of the present invention. Such a technique may differ from other techniques described in this application relating to the collection non-POT objects. For example, according to one embodiment, the earliest LVI) value corresponding to a saved object version may be extracted from the LV Tree. Using this LVID value, the Object Table is then checked for a MOT entry which is immediately less than or equal to the LVID value. If an appropriate MOT entry is found, then the version entry in the POT page, which is earlier than the LVID value, may be discarded.

In the embodiment of FIG. 12, the Version Collection Procedure C utilizes information from the Object Table and information from a Version Collection Disk MAP (VC Disk MAP) in performing its version collection operations. An example of VC Disk MAP is illustrated in FIG. 14.

FIG. 14 shows a block diagram of a VC Disk MAP 1400 in accordance with a specific embodiment of the present invention. According to one implementation, each bit in the VC Disk MAP may be mapped to a particular disk page in the persistent memory. For example, bit 1401 of VC Disk MAP 1400 may correspond to Disk Page A 152A of FIG. 1B, and bit 1402 may correspond to Disk Page B 152B of FIG. 1B.

According to a specific implementation, the VC Disk MAP may be used by the Version Collection Procedure C to keep track of collectible and/or uncollectible disk pages. For example, according to one implementation, a bit value of 0 in the VC Disk MAP may signify that either (1) the corresponding disk page in the persistent memory includes a single, obsolete object which may be collected, or (2) the corresponding disk page in the persistent memory is not referenced by any of the Object Table entries in the Object Table (after any necessary unswizzling operations have been performed, for example). Alternatively, a bit value of “1” in the VC Disk MAP may signify that the corresponding disk page in the persistent memory is not collectible, or that the disk page corresponds to a persistent object table (POT) disk page. It will be appreciated that the examples above merely represent one embodiment of the present invention, and that the present invention may be modified by one having ordinary skill in the art. For example, according to an alternate embodiment, the significance attributed to the “0” and “1” bit values in the VC MAP may be reversed. In a specific implementation, the VC Disk MAP may be stored in working memory or volatile memory for relatively fast access of information stored therein.

Returning to FIG. 12, initially, as shown at 1201, all bits in the VC Disk MAP may be initialized or set to specific values. According to a specific embodiment, all bits in the VC Disk MAP are initialized to a specific value (e.g. zero) to indicate that the corresponding disk pages in the persistent memory may be freed. As shown at 1202, a locked version tree is created and the MAX_VER value appended to it. Thereafter, the Get Object Version ID Procedure B (FIG. 5B) may be implemented (1204) for each object version identified in the Object Table. Once a particular OVID value has been obtained for an identified object version, an Object Collection Analysis Procedure such as, for example, that shown in FIG. 13, may be implemented (1206) in order to determine whether the identified object version is obsolete. A detailed description of the Object Collection Analysis Procedure of FIG. 13 is provided below.

After the Object Collection Analysis Procedure of FIG. 13 has been implemented for each identified object version in the Object Table, the VC Disk MAP will include updated information relating to disk pages in the persistent memory which may be freed as a result of the version collection analysis. In a specific implementation, the VC Disk MAP may include at least two types of status indicators for indicating a status of each corresponding disk page in the persistent memory. In one embodiment, the status indicators include a “free disk page” status indicator, and a “save disk page” status indicator, which may be represented by different bit values. For example, a bit value of “0” in the VC Disk MAP may be used to indicate that a particular disk page in the persistent memory is associated with the “free disk page” status, and therefore may be freed; whereas a bit value of “1” may be used to indicate that a particular disk page in the persistent memory is associated with a “save disk page” status, and therefore is not to be freed.

As shown at 1208, the VC Disk MAP information may be used to free the appropriate disk pages in the persistent memory which have been identified as having a “free disk page” status, if such disk pages have not already been freed. In a specific implementation, “free disk page” status may be assigned to disk pages which contain single page, obsolete object versions.

FIG. 13 shows a flow diagram of an Object Collection Analysis Procedure C 1300 in accordance with a specific embodiment of the present invention. Initially, as shown at 1302, a plurality of input parameters are received relating to one or more object identified for version collection analysis. The input parameters include, for example, an OID value and an OVID value for each identified object. According to a specific embodiment, the Object Collection Analysis Procedure C may be configured to handle a plurality of input parameters relating to different object versions. However, for purposes of illustration, and in order to avoid confusion, the Object Collection Analysis Procedure C will be described in terms of its application to an identified object version which has been selected for version collection analysis.

At 1304 the LV Tree is consulted in order to find an LVID value which is immediately greater than or equal to the OVID value of the identified object. This process is described in greater detail, for example, with respect to operation 604 of FIG. 6.

Once an appropriate LVID value has been determined at 1304, an object table lookup operation may then be performed (1306) in order to find a most relevant OTVID associated with the OID at a logical time corresponding to the LVID value. This process is described in greater detail, for example, with regard to operation 606 of FIG. 6.

Once the appropriate OTVID value has been obtained during the object table lookup operation, a determination may then be made (1308) as to whether the OTVID value is equal to the OVID value. If it is determined that the OTVID value is the same as the OVID value, then it may be concluded that the currently selected object version is not to be collected or garbaged. Accordingly, an appropriate flag or bit in the VC Disk MAP (corresponding to the disk page in the persistent memory where the selected object is stored) may be set (1318) to a particular value (e.g. “1”) to indicate that the status of the identified disk page is “save disk page”, meaning that the identified disk page is not to be freed at the end of the current iteration of the Version Collection Procedure C.

If, however, it is determined that the OTVID value is not equal to the OVID value, then a determination is made (1310) as to whether the selected object version corresponds to a POT page. If so, an appropriate flag or bit in the VC Disk MAP (corresponding to the disk page in the persistent memory where the selected object is stored) may be set (1318) to a particular value (e.g. “1”) to indicate that the status of the identified disk page is “save disk page”, meaning that the identified disk page is not to be freed at the end of the current iteration of the Version Collection Procedure C.

If it is determined that the selected object does not correspond to a POT page, and that the version ID (OVID) of the selected object is not equal to the OTVID value derived at operation 1306, then it may be assumed that the selected object corresponds to an obsolete object version. Accordingly, the Object Table entry corresponding to the selected OVID (if present) may be garbaged or deleted (1314).

According to a specific embodiment (not shown in FIG. 13) a determination may then be made as to whether the selected object version is stored as a single page object in the persistent memory. If it is determined that the identified object version is stored as single disk page in the persistent memory, then the identified obsolete object version may be garbaged from the persistent memory, such as, for example, by freeing the disk page in the persistent memory which stores the identified obsolete object version.

It will be appreciated that, in the specific embodiment of FIGS. 12 and 13, it is assumed that a bit value of “0” in the VC Disk MAP is used to indicate that the corresponding disk page in the persistent memory is to be freed. Since all bit values in the VC Disk MAP are set initially to “0” (at 1201 of FIG. 12), it is initially assumed that all disk pages in the persistent memory which are mapped by the VC Disk MAP will be freed. During execution of the Version Collection Analysis Procedure C specific disk pages may be identified as disk pages which are not to be freed. According to a specific embodiment, when a particular disk page has been identified as one which is to be saved (i.e. not freed), the bit flag corresponding to that disk page may be set equal to “1”. Thus, if it is determined that the selected object version corresponds to an obsolete object version, the Object Table entry corresponding to the obsolete object version may be garbaged or deleted from the Object Table (if present). Therafter, in accordance with a specific embodiment, no action need be performed upon the flag bit in the VC Disk MAP corresponding to that disk page since the value of the flag bit is already set equal to “0”.

At the completion of the Object Collection Analysis Procedure C, all disk pages in the persistent memory which have been identified as disk pages which are not to be freed should preferably have a corresponding bit value of “1” in the VC Disk MAP.

After all or a selected portion of the entries in the Object Table have been analyzed for version collection analysis in accordance with the Version Collection Procedure C, the information contained in the updated VC Disk MAP may be used to free (1208) all appropriate disk pages in the persistent memory (which have not already been freed) corresponding to flags or bits in the persistent memory which have been set to “free disk page” status (e.g. bits which are set equal to “0”). Additionally, according to a specific embodiment, a checkpointing procedure may be implemented in order to checkpoint data which has been stored in the persistent memory. An example of a checkpointing procedure is described in FIG. 21 of the Parent Application.

After the free disk page operation at 1208 has been completed, the persistent memory should preferably contain only those disk pages which are mapped to a corresponding bit value of “1” (or other value used for indicating that a particular disk page is not to be deleted) in the VC Disk MAP. Thereafter, during the next iteration of the Version Collection Procedure C, the bits in the VC Disk MAP will again be reinitialized to “0”, and, if during the next iteration of the Version Collection Procedure C, there is no operation which causes the bit of a corresponding disk page from being set to “1” then that disk page will be deleted at operation 1208.

In order to further clarify additional aspects relating to the Version Collection Procedure C of FIG. 12, an example will now be described with reference to FIG. 1A of the drawings. In this example, it is assumed that Disk Page B 152B contains one obsolete object version, namely Object B, Version 0, and contains one non-obsolete object version, namely Object A, Version 1. Additionally, it is assumed that Disk Page A 152A contains one obsolete object version, namely Object A, Version 0. Thus, when the Version Collection Procedure C is implemented, Object Table entries 104A and 104C will both be identified as being related to obsolete object versions during the Object Collection Analysis Procedure C. Accordingly, Object Table entries 104A and 104C will be deleted at operation 1314 of FIG. 13. However, since Disk Page B also contains a non-obsolete object version (e.g. Object B, Version 0), the bit in the VC Disk MAP corresponding to Disk Page B will be set equal to “1” at 1318. Accordingly, at the conclusion of the first iteration of the Version Collection Procedure C, entries 104A and 104C will have been deleted from the Object Table 161, but the Disk Page B will not have been erased or freed, and therefore will still contain both the obsolete object version (Object A, Version 1) and the non-obsolete object version (Object B, Version 0). Additionally, Disk Page A 152A will also exist in the persistent memory until the next iteration of the Version Collection Procedure C.

Upon the next iteration of the Version Collection Procedure C, the bits in the VC Disk MAP corresponding to Disk Page A and Disk Page B will be reset to “0” at 1201. As the Version Collection Procedure C checks each entry in the Object Table 161 to see whether that entry corresponds to an obsolete object version, the Version Collection Procedure C will encounter no entries in the Object Table which point to Disk Page A. Accordingly, at the conclusion of 1206, the bit flag in the VC Disk MAP corresponding to Disk Page A will remain set equal to “0”. Thereafter, at 1208, Disk Page A will be freed.

In accordance with an alternate embodiment of the present invention, the VC Disk MAP information corresponding to each disk page in the persistent memory may be stored in an Allocation MAP (such as that described in FIG. 17 of the Parent Application). For example, in one embodiment, the VC Disk MAP information for a selected disk page may be stored in an Allocation MAP entry corresponding to that disk page. In such an embodiment the VC Disk MAP may be eliminated since its information will be included in the Allocation MAP.

Other Embodiments

Generally, the information storage and retrieval techniques of the present invention may be implemented on software and/or hardware. For example, they can be implemented in an operating system kernel, in a separate user process, in a library package bound into network applications, on a specially constructed machine, or on a network interface card. In a specific embodiment of this invention, the technique of the present invention is implemented in software such as an operating system or in an application running on an operating system.

A software or software/hardware hybrid implementation of the information storage and retrieval technique of this invention may be implemented on a general purpose programmable machine selectively activated or reconfigured by a computer program stored in memory. Such programmable machine may be a network device designed to handle network traffic. The network device may be configured to include multiple network interfaces including frame relay, ATM, TCP, ISDN, etc. Specific examples of such network devices include routers, switches, servers, etc. In such network configurations, it will be appreciated that the reduction or elimination of disk access afforded by the present invention during version collection, and the more efficient checkpointing operation that results, also significantly reduces or eliminates system delays associated with network latency and increased network traffic.

A general architecture for some of these machines will appear from the description given below. In an alternative embodiment, the information storage and retrieval technique of this invention may be implemented on a general-purpose network host machine such as a personal computer or workstation. Further, the invention may be at least partially implemented on a card (e.g., an interface card) for a network device or a general-purpose computing device.

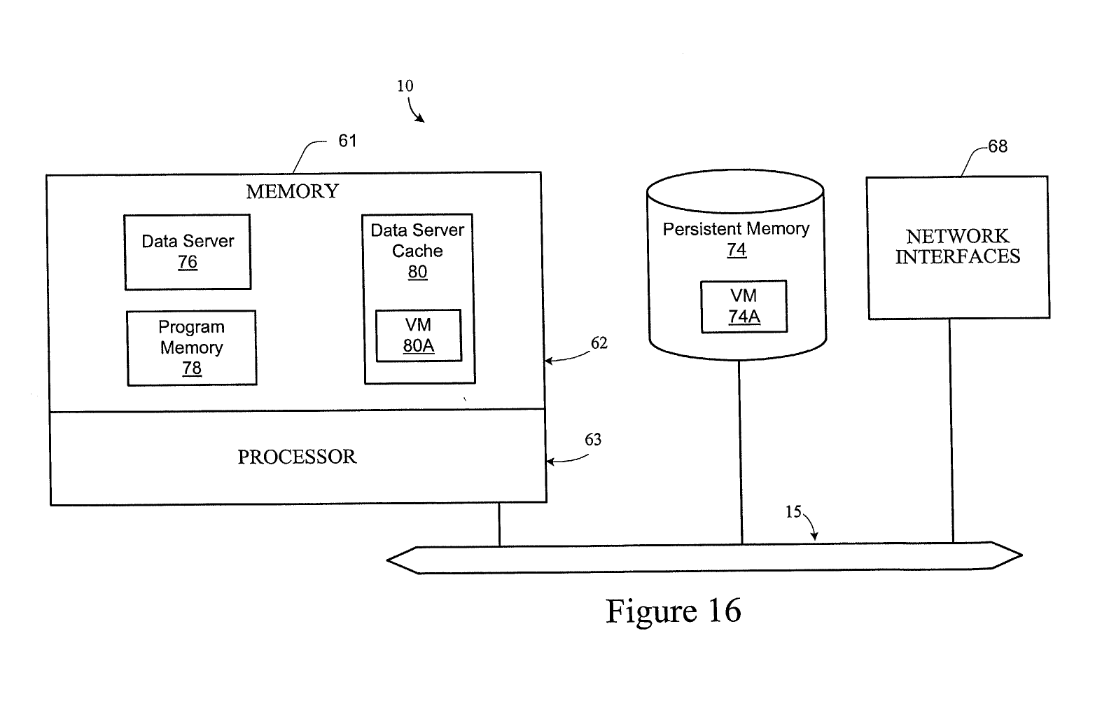

Referring now to FIG. 16, a network device 10 suitable for implementing the information storage and retrieval technique of the present invention includes at least one central processing unit (CPU) 61, at least one interface 68, memory 62, and at least one bus 15 (e.g., a PCI bus). When acting under the control of appropriate software or firmware, the CPU 61 may be responsible for implementing specific functions associated with the functions of a desired network device. When configured as a database server, the CPU 61 may be responsible for such standard database tasks as, for example, managing internal data structures and data, managing atomic transaction updates, managing memory cache operations, performing checkpointing and version collection functions, maintaining database integrity, replicating database information, responding to database queries, etc. The CPU 61 preferably accomplishes all these functions under the control of software, including an operating system (e.g. Windows NT, SUN SOLARIS, LINUX, HPUX, IBM RS 6000, etc.), and any appropriate applications software. It will be appreciated that the combination of intrinsic versioning in a non-log based information storage and retrieval system with the improved version collection procedure of the present invention permits simultaneous operation of the database while version collection is underway, permitting a high volume of database activity and high concurrency access to the database even during version collection and other administrative operations.

CPU 61 may include one or more processors 63 such as a processor from the Motorola family of microprocessors or the MIPS family of microprocessors. In an alternative embodiment, processor 63 may be specially designed hardware for controlling the operations of network device 10. In a specific embodiment, memory 62 (such as non-volatile RAM and/or ROM) also forms part of CPU 61. However, there are many different ways in which memory could be coupled to the system. Memory block 62 may be used for a variety of purposes such as, for example, caching and/or storing data, programming instructions, etc. For example, the memory 62 may include program instructions for implementing functions of a data server 76. According to a specific embodiment, memory 62 may also include program memory 78 and a data server cache 80. The data server cache 80 may include a virtual memory (VM) component 80A, which, together with the virtual memory component 74A of the non-volatile memory 74, may be used to provide virtual memory functionality to the information storage and retrieval system of the present invention.

According to at least one embodiment, the network device 10 may also include persistent or non-volatile memory 74. Examples of non-volatile memory include hard disks, floppy disks, magnetic tape, optical media such as CD-ROM disks, magneto-optical media such as floptical disks, etc.

The interfaces 68 are typically provided as interface cards (sometimes referred to as “line cards”). Generally, they control the sending and receiving of data packets over the network and sometimes support other peripherals used with the network device 10. Among the interfaces that may be provided are Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 61 to efficiently perform routing computations, network diagnostics, security functions, etc.

Although the system shown in FIG. 16 illustrates one specific network device of the present invention, it is by no means the only network device architecture on which the present invention can be implemented. For example, an architecture having a single processor that handles communications as well as routing computations, etc. may be used. Further, other types of interfaces and media could also be used with the network device.

Regardless of network device's configuration, it may employ one or more memories or memory modules (such as, for example, memory block 62) configured to store data, program instructions for the general-purpose network operations and/or other information relating to the functionality of the information storage and retrieval techniques described herein. The program instructions may control the operation of an operating system and/or one or more applications, for example. The memory or memories may also be configured to include data structures which store object tables, disk pages, disk page buffers, data object, allocation maps, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave travelling over an appropriate medium such as airwaves, optical lines, electric lines, etc. Examples of program instructions include both machine code, such as produced by a compiler, and files containing higher level code that may be -executed by the computer using an interpreter.

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

It is claimed:

1. A method for implementing collection of obsolete object versions stored in an information storage and retrieval system, the information storage and retrieval system including persistent memory configured or designed to store a plurality of different object versions, the information storage and retrieval system further including volatile memory, the volatile memory including an object table, the object table configured or designed to include object version information relating to the plurality of object versions, the object version information including information relating to locations in the persistent memory where each of the plurality of object versions are stored, the method comprising:
initiating a version collection procedure; and
identifying at least one object version as an obsolete object version without performing a memory access operation to the persistent memory to retrieve information relating to the at least one object version.

2. The method of claim 1 further comprising identifying at least one object for version collection analysis without performing a memory access operation to the persistent memory to retrieve information relating to the at least one object.

3. The method of claim 1 further comprising freeing a selected disk page in the persistent memory without performing a memory access operation to the persistent memory to retrieve information relating to the contents of the selected disk page.

4. The method of claim 3 further comprising determining that the selected disk page should be freed based upon information contained in the object table.

5. The method of claim 1 further wherein the identification of the obsolete object version is accomplished using information contained in the object table

6. The method of claim 1 further comprising identifying at least one object which is a candidate for version collection analysis using information contained in the object table.

7. The method of claim 1 further comprising determining whether the obsolete object version is stored in the persistent memory as a single disk page.

8. The method of claim 1 wherein the object table includes a first object table entry corresponding to the identified obsolete object version, and
wherein the first object table entry includes single disk page information relating to whether the entirety of the identified obsolete object version is stored on a single disk page in the persistent memory.

9. The method of claim 1 further comprising storing information in the object table relating to whether a selected object version is stored as a single disk page in the persistent memory.

10. The method of claim 1 further comprising creating a locked version data structure, the locked version data structure including information relating to identities of non-collectible object versions.

11. The method of claim 10 wherein the locked version data structure further includes information relating to an identity of a last object version to be created before initiation of the version collection procedure.

12. The method of claim 1 further comprising storing a VC Disk Map in local memory, the VC Disk Map including a plurality of bits, wherein each bit is associated with a corresponding disk page in the persistent memory, and
wherein each bit may be set to a desired value which is used to represent a status of its corresponding disk page; and
wherein said desired value may include a first value for indicating that information stored on the corresponding disk may be freed or released;
and wherein said desired value may include a second value for indicating that information stored on the corresponding disk is to be saved.

13. The method of claim 1 wherein the information storage and retrieval system corresponds to a non-log based information storage and retrieval system; and
wherein the information storage and retrieval system is configured or designed to implement intrinsic versioning of objects stored within the system.

14. The method of claim 1 further comprising performing a user initiated database access operation to the persistent memory after completion of the version collection procedure.

15. The method of claim 1 further comprising performing a user initiated database access operation to the persistent memory concurrently during execution of the version collection procedure.

16. The method of claim 1 further comprising initiating a checkpointing operation upon completion of the version collection procedure.

17. The method of claim 1 further comprising restoring database information using checkpointed information obtained from persistent memory.

18. The method of claim 17 wherein said restoring is performed without accessing a transaction log.

19. The method of claim 17 wherein said checkpointed information corresponds to information stored in persistent memory after completion of said version collection procedure.

20. The method of claim 1 further comprising replicating information stored in the persistent memory upon completion of said version collection procedure.

21. The method of claim 1 further comprising replicating information stored in the persistent memory upon completion of a checkpointing procedure.

22. The method of claim 21 wherein said checkpointing procedure results in checkpointed information being stored in persistent memory.

23. The method of claim 21 wherein said replicating is performed without using a transaction log.

24. A computer program product, the computer program product including a computer usable medium having computer readable code embodied therein, the computer readable code comprising computer code for implementing the method of claim 1.

25. A method for implementing collection of obsolete object versions stored in an information storage and retrieval system, the information storage and retrieval system including persistent memory configured or designed to store a plurality of different object versions, the information storage and retrieval system further including volatile memory, the volatile memory including an object table, the object table configured or designed to include object version information relating to the plurality of object versions, the object version information including information relating to locations in the persistent memory where each of the plurality of object versions are stored, the method comprising:
initiating a version collection procedure; and
identifying at least one object version as an obsolete object version;
wherein the identifying of the at least one obsolete object version is accomplished using information stored entirely in volatile memory.

26. The method of claim 25 further comprising identifying at least one object for version collection analysis without performing a memory access operation to the persistent memory to retrieve information relating to the at least one object.

27. The method of claim 25 further comprising freeing a selected disk page in the persistent memory without performing a memory access operation to the persistent memory to retrieve information relating to the contents of the selected disk page.

28. The method of claim 27 further comprising determining that the selected disk page should be freed based upon information contained in the object table.

29. The method of claim 25 further wherein the identification of the obsolete object version is accomplished using information contained in the object table

30. The method of claim 25 further comprising identifying at least one object which is a candidate for version collection analysis using information contained in the object table.

31. The method of claim 25 further comprising determining whether the obsolete object version is stored in the persistent memory as a single disk page.

32. The method of claim 25 wherein the object table includes a first object table entry corresponding to the identified obsolete object version, and
wherein the first object table entry includes single disk page information relating to whether the entirety of the identified obsolete object version is stored on a single disk page in the persistent memory.

33. The method of claim 25 further comprising storing information in the object table relating to whether a selected object version is stored as a single disk page in the persistent memory.

34. The method of claim 25 further comprising creating a locked version data structure, the locked version data structure including information relating to identities of non-collectible object versions.

35. The method of claim 44 wherein the locked version data structure further includes information relating to an identity of a last object version to be created before initiation of the version collection procedure.

36. The method of claim 25 further comprising storing a VC Disk Map in local memory, VC Disk Map the including a plurality of bits, wherein each bit is associated with a corresponding disk page in the persistent memory, and
wherein each bit may be set to a desired value which is used to represent a status of its corresponding disk page; and
wherein said desired value may include a first value for indicating that information stored on the corresponding disk may be freed or released;
and wherein said desired value may include a second value for indicating that information stored on the corresponding disk is to be saved.

37. The method of claim 25 wherein the information storage and retrieval system corresponds to a non-log based information storage and retrieval system; and
wherein the information storage and retrieval system is configured or designed to implement intrinsic versioning of objects stored within the system.

38. A computer program product, the computer program product including a computer usable medium having computer readable code embodied therein, the computer readable code comprising computer code for implementing the method of claim 25.

39. An information storage and retrieval system for implementing collection of obsolete object versions stored therein, the system comprising:
at least one processor; and
memory;
the memory including persistent memory configured or designed to store a plurality of different object versions;
the memory further including volatile memory,
said at least one processor being configured to store in said volatile memory a plurality of data structures, including an object table, the object table being configured to include object version information relating to the plurality of object versions, the object version information including information relating to locations in the persistent memory where each of the plurality of object versions are stored;
the system being configured or designed to initiate a version collection procedure; and
the system being further configured or designed to identify at least one object version as an obsolete object version without performing a memory access operation to the persistent memory to retrieve information relating to the at least one object version.

40. The system of claim 39 being further configured or designed to identify at least one object for version collection analysis without performing a memory access operation to the persistent memory to retrieve information relating to the at least one object.

41. The system of claim 39 being further configured or designed to free a selected disk page in the persistent memory without performing a memory access operation to the persistent memory to retrieve information relating to the contents of the selected disk page.

42. The system of claim 41 being further configured or designed to determine that the selected disk page should be freed based upon information contained in the object table.

43. The system of claim 39 further wherein the identification of the obsolete object version is accomplished using information contained in the object table

44. The system of claim 39 being further configured or designed to identify at least one object which is a candidate for version collection analysis using information contained in the object table.

45. The system of claim 39 being further configured or designed to determine whether the obsolete object version is stored in the persistent memory as a single disk page.

46. The system of claim 39 wherein the object table includes a first object table entry corresponding to the identified obsolete object version, and
wherein the first object table entry includes single disk page information relating to whether the entirety of the identified obsolete object version is stored on a single disk page in the persistent memory.

47. The system of claim 39 being further configured or designed to store information in the object table relating to whether a selected object version is stored as a single disk page in the persistent memory.

48. The system of claim 39 being further configured or designed to create a locked version data structure, the locked version data structure including information relating to identities of non-collectible object versions.

49. The system of claim 48 wherein the locked version data structure further includes information relating to an identity of a last object version to be created before initiation of the version collection procedure.

50. The system of claim 39 being further configured or designed to store a VC Disk Map in local memory, VC Disk Map the including a plurality of bits, wherein each bit is associated with a corresponding disk page in the persistent memory, and
wherein each bit may be set to a desired value which is used to represent a status of its corresponding disk page; and
wherein said desired value may include a first value for indicating that information stored on the corresponding disk may be freed or released;
and wherein said desired value may include a second value for indicating that information stored on the corresponding disk is to be saved.

51. The system of claim 39 wherein the information storage and retrieval system corresponds to a non-log based information storage and retrieval system; and
wherein the information storage and retrieval system is configured or designed to implement intrinsic versioning of objects stored within the system.

52. An information storage and retrieval system for implementing collection of obsolete object versions stored therein, the system comprising:
at least one processor; and
memory;
the memory including persistent memory configured or designed to store a plurality of different object versions;
the memory further including volatile memory,
said at least one processor being configured to store in said volatile memory a plurality of data structures, including an object table, the object table being configured to include object version information relating to the plurality of object versions, the object version information including information relating to locations in the persistent memory where each of the plurality of object versions are stored;
the system being configured or designed to initiate a version collection procedure; and
the system being further configured or designed to identify at least one object version as an obsolete object version;
wherein the identifying of the at least one obsolete object version is accomplished using information stored entirely in volatile memory.

53. The system of claim 52 being further configured or designed to identify at least one object for version collection analysis without performing a memory access operation to the persistent memory to retrieve information relating to the at least one object.

54. The system of claim 52 being further configured or designed to free a selected disk page in the persistent memory without performing a memory access operation to the persistent memory to retrieve information relating to the contents of the selected disk page.

55. The system of claim 54 being further configured or designed to determine that the selected disk page should be freed based upon information contained in the object table.

56. The system of claim 52 further wherein the identification of the obsolete object version is accomplished using information contained in the object table

57. The system of claim 52 being further configured or designed to identify at least one object which is a candidate for version collection analysis using information contained in the object table.

58. The system of claim 52 being further configured or designed to determine whether the obsolete object version is stored in the persistent memory as a single disk page.

59. The system of claim 52 wherein the object table includes a first object table entry corresponding to the identified obsolete object version, and
wherein the first object table entry includes single disk page information relating to whether the entirety of the identified obsolete object version is stored on a single disk page in the persistent memory.

60. The system of claim 52 being further configured or designed to store information in the object table relating to whether a selected object version is stored as a single disk page in the persistent memory.

61. The system of claim 52 being further configured or designed to create a locked version data structure, the locked version data structure including information relating to identities of non-collectible object versions.

62. The system of claim 61 wherein the locked version data structure further includes information relating to an identity of a last object version to be created before initiation of the version collection procedure.

63. The system of claim 52 being further configured or designed to store a VC Disk Map in local memory, VC Disk Map the including a plurality of bits, wherein each bit is associated with a corresponding disk page in the persistent memory, and
wherein each bit may be set to a desired value which is used to represent a status of its corresponding disk page; and
wherein said desired value may include a first value for indicating that information stored on the corresponding disk may be freed or released;
and wherein said desired value may include a second value for indicating that information stored on the corresponding disk is to be saved.

64. The system of claim 52 wherein the information storage and retrieval system corresponds to a non-log based information storage and retrieval system; and
wherein the information storage and retrieval system is configured or designed to implement intrinsic versioning of objects stored within the system.

65. A computer program product for implementing collection of obsolete object versions stored in an information storage and retrieval system, the information storage and retrieval system including persistent memory configured or designed to store a plurality of different object versions, the information storage and retrieval system further including volatile memory, the volatile memory including an object table, the object table configured or designed to include object version information relating to the plurality of object versions, the object version information including information relating to locations in the persistent memory where each of the plurality of object versions are stored, the computer program product comprising:
a computer usable medium having computer readable code embodied therein, the computer readable code comprising:
computer code for initiating a version collection procedure; and
computer code for identifying at least one object version as an obsolete object version without performing a memory access operation to the persistent memory to retrieve information relating to the at least one object version.

66. The computer program product of claim 65 further comprising computer code for identifying at least one object for version collection analysis without performing a memory access operation to the persistent memory to retrieve information relating to the at least one object.

67. The computer program product of claim 65 further comprising computer code for freeing a selected disk page in the persistent memory without performing a memory access operation to the persistent memory to retrieve information relating to the contents of the selected disk page.

68. The computer program product of claim 67 further comprising computer code for determining that the selected disk page should be freed based upon information contained in the object table.

69. The computer program product of claim 65 further wherein the identification of the obsolete object version is accomplished using information contained in the object table

70. The computer program product of claim 65 further comprising computer code for identifying at least one object which is a candidate for version collection analysis using information contained in the object table.

71. The computer program product of claim 65 further comprising computer code for determining whether the obsolete object version is stored in the persistent memory as a single disk page.

72. The computer program product of claim 65 wherein the object table includes a first object table entry corresponding to the identified obsolete object version, and
wherein the first object table entry includes single disk page information relating to whether the entirety of the identified obsolete object version is stored on a single disk page in the persistent memory.

73. The computer program product of claim 65 further comprising computer code for storing information in the object table relating to whether a selected object version is stored as a single disk page in the persistent memory.

74. The computer program product of claim 65 further comprising computer code for creating a locked version data structure, the locked version data structure including information relating to identities of non-collectible object versions.

75. The computer program product of claim 74 wherein the locked version data structure further includes information relating to an identity of a last object version to be created before initiation of the version collection procedure.

76. The computer program product of claim 65 further comprising computer code for storing a VC Disk Map in local memory, VC Disk Map the including a plurality of bits, wherein each bit is associated with a corresponding disk page in the persistent memory, and
wherein each bit may be set to a desired value which is used to represent a status of its corresponding disk page; and
wherein said desired value may include a first value for indicating that information stored on the corresponding disk may be freed or released;
and wherein said desired value may include a second value for indicating that information stored on the corresponding disk is to be saved.

77. The computer program product of claim 65 wherein the information storage and retrieval system corresponds to a non-log based information storage and retrieval system; and
wherein the information storage and retrieval system is configured or designed to implement intrinsic versioning of objects stored within the system.

78. A computer program product for implementing collection of obsolete object versions stored in an information storage and retrieval system, the information storage and retrieval system including persistent memory configured or designed to store a plurality of different object versions, the information storage and retrieval system further including volatile memory, the volatile memory including an object table, the object table configured or designed to include object version information relating to the plurality of object versions, the object version information including information relating to locations in the persistent memory where each of the plurality of object versions are stored, the computer program product comprising:
computer code for initiating a version collection procedure; and
computer code for identifying at least one object version as an obsolete object version;
wherein the identifying of the at least one obsolete object version is accomplished using information stored entirely in volatile memory.

79. The computer program product of claim 78 further comprising computer code for identifying at least one object for version collection analysis without performing a memory access operation to the persistent memory to retrieve information relating to the at least one object.

80. The computer program product of claim 78 further comprising computer code for freeing a selected disk page in the persistent memory without performing a memory access operation to the persistent memory to retrieve information relating to the contents of the selected disk page.

81. The computer program product of claim A70 further comprising computer code for determining that the selected disk page should be freed based upon information contained in the object table.

82. The computer program product of claim 78 further wherein the identification of the obsolete object version is accomplished using information contained in the object table

83. The computer program product of claim 78 further comprising computer code for identifying at least one object which is a candidate for version collection analysis using information contained in the object table.

84. The computer program product of claim 78 further comprising computer code for determining whether the obsolete object version is stored in the persistent memory as a single disk page.

85. The computer program product of claim 78 wherein the object table includes a first object table entry corresponding to the identified obsolete object version, and
wherein the first object table entry includes single disk page information relating to whether the entirety of the identified obsolete object version is stored on a single disk page in the persistent memory.

86. The computer program product of claim 78 further comprising computer code for storing information in the object table relating to whether a selected object version is stored as a single disk page in the persistent memory.

87. The computer program product of claim 78 further comprising computer code for creating a locked version data structure, the locked version data structure including information relating to identities of non-collectible object versions.

88. The computer program product of claim 87 wherein the locked version data structure further includes information relating to an identity of a last object version to be created before initiation of the version collection procedure.

89. The computer program product of claim 78 further comprising computer code for storing a VC Disk Map in local memory, VC Disk Map the including a plurality of bits, wherein each bit is associated with a corresponding disk page in the persistent memory, and
wherein each bit may be set to a desired value which is used to represent a status of its corresponding disk page; and
wherein said desired value may include a first value for indicating that information stored on the corresponding disk may be freed or released;
and wherein said desired value may include a second value for indicating that information stored on the corresponding disk is to be saved.

90. The computer program product of claim 78 wherein the information storage and retrieval system corresponds to a non-log based information storage and retrieval system; and
wherein the information storage and retrieval system is configured or designed to implement intrinsic versioning of objects stored within the system.

91. A method for implementing collection of obsolete object versions stored in an information storage and retrieval system, the information storage and retrieval system including persistent memory configured or designed to store a plurality of different object versions, the information storage and retrieval system further including volatile memory, the volatile memory including an object table, the object table configured or designed to include object version information relating to the plurality of object versions, the object version information including information relating to locations in the persistent memory where each of the plurality of object versions are stored, the method comprising:
means for initiating a version collection procedure; and
means for identifying at least one object version as an obsolete object version;
wherein the identifying of the at least one obsolete object version is accomplished using information stored entirely in volatile memory.

92. The method of claim 91 further comprising means for identifying at least one object for version collection analysis without performing a memory access operation to the persistent memory to retrieve information relating to the at least one object.

93. The method of claim 91 further comprising means for freeing a selected disk page in the persistent memory without performing a memory access operation to the persistent memory to retrieve information relating to the contents of the selected disk page.

94. The method of claim 93 further comprising means for determining that the selected disk page should be freed based upon information contained in the object table.

95. The method of claim 91 further wherein the identification of the obsolete object version is accomplished using information contained in the object table

96. The method of claim 91 further comprising means for identifying at least one object which is a candidate for version collection analysis using information contained in the object table.

97. The method of claim 91 further comprising means for determining whether the obsolete object version is stored in the persistent memory as a single disk page.

98. The method of claim 91 wherein the object table includes a first object table entry corresponding to the identified obsolete object version, and
wherein the first object table entry includes single disk page information relating to whether the entirety of the identified obsolete object version is stored on a single disk page in the persistent memory.

99. The method of claim 91 further comprising means for storing information in the object table relating to whether a selected object version is stored as a single disk page in the persistent memory.

100. The method of claim 91 further comprising means for creating a locked version data structure, the locked version data structure including information relating to identities of non-collectible object versions.

101. The method of claim 100 wherein the locked version data structure further includes information relating to an identity of a last object version to be created before initiation of the version collection procedure.

102. The method of claim 91 further comprising means for storing a VC Disk Map in local memory, VC Disk Map the including a plurality of bits, wherein each bit is associated with a corresponding disk page in the persistent memory, and
wherein each bit may be set to a desired value which is used to represent a status of its corresponding disk page; and
wherein said desired value may include a first value for indicating that information stored on the corresponding disk may be freed or released;
and wherein said desired value may include a second value for indicating that information stored on the corresponding disk is to be saved.

103. The method of claim 91 wherein the information storage and retrieval system corresponds to a non-log based information storage and retrieval system; and
wherein the information storage and retrieval system is configured or designed to implement intrinsic versioning of objects stored within the system.
